(19) United States
(12) Patent Application Publication
(10) Pub. No.: US 2004/0233223 A1
(43) Pub. Date: Nov. 25, 2004

(54) Physical/digital input methodologies for spatial manipulations and entertainment

(76) Inventors: Steven Schkolne, Los Angeles, CA (US); Peter Schroder, Altadena, CA (US)

Correspondence Address: COUDERT BROTHERS LLP, 333 SOUTH HOPE STREET, 23RD FLOOR, LOS ANGELES, CA, 90071, US

(21) Appl. No.: 10/791,972

(22) Filed: Mar. 2, 2004

Related U.S. Application Data
(60) Provisional application No. 60/472,626, filed on May 22, 2003.

(51) Int. Cl. G09G 5/00; G06T 17/00

(52) U.S. Cl. 345/621; 345/420

(57) ABSTRACT

The invention provides improved interface tools, both physical and digital for performing two and three-dimensional spatial manipulation and two and three-dimensional gaming using a set of tangible tools. These tools are shaped to specific forms mimicking the tools' primary function. For example, one of the tools is shaped to resemble a pair of kitchen tongs, which gives the user the immediate perception that they are to be used for grabbing. Two physical or digital input devices can be used in conjunction to alter virtual objects. The invention also presents several novel tools to alter and generate three-dimensional objects, for example using an eraser tool, a deformation tool, a spray-painting tool, a smoothing tool, and a texture creation tool. The invention presents several novel means of interacting with video games using the tools mentioned above as a replacement for the standard joystick.

### CROSS-REFERENCE TO RELATED APPLICATION(S)

The present application claims the benefit of priority from pending U.S. Provisional Patent Application No. 60/472,626, entitled “Physical/Digital Input Devices For 3D Spatial Manipulation”, filed on May 22, 2003, which is herein incorporated by reference in its entirety.

### BACKGROUND OF THE INVENTION

1. Field of the Invention

The present invention relates to the field of using both physical and digital input methodologies to implement both two and three-dimensional spatial manipulation and two and three-dimensional entertainment.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Computers have become a resource for modeling complex spatial structural designs. With the progression in technology, very complex three-dimensional designs have become ubiquitous in many fields. These three-dimensional depictions are used to represent designs of varied scale, ranging from nanoscale molecular machines to large architectural city structures. For advanced progress of the creation of these designs, it is very important for a designer to be able to translate a three-dimensional design idea into a digital representation.

Currently, many designers use two-dimensional graphical user interfaces (GUIs) to model their three-dimensional designs. A two-dimensional GUI consists of some type of cursor controller, for example a mouse, which usually is only able to control two coordinates, namely X and Y. Since a typical mouse can only be moved in a two-dimensional plane, the GUI has only two input degrees of freedom (DOF). Thus, the position of the mouse can only be translated along the X axis and along the Y axis.

A disadvantage to these two-dimensional GUIs is that they rarely allow the designer to seamlessly create a digital representation of a three-dimensional design. There are a couple of reasons why two-dimensional GUIs present interruptions to the design process. One reason is that since two-dimensional GUIs only translate position along the X axis and Y axis, a designer has to stop the digital design process and rotate the entire virtual scene to draw virtual objects along the Z axis. These interruptions can have detrimental effects to the design process by breaking the designer's stream-of-thoughts during the design process by making the design process longer.

The other reason is based on the fact that most of these two-dimensional GUIs use one generic mouse as an input device. A generic mouse usually contains only two buttons, which are available to be used for modal selection. This presents another obstacle to the design process because since design software usually contains many different drawing tools and there are only two available mouse buttons, the selection of a drawing tool can usually only be achieved by some sort of awkward means, e.g., by simultaneously depressing the Alt-Shift keyboard buttons along with one of the mouse buttons. Since this awkward activation requires additional thought, it can also cause the deleterious effects of breaking the designer's thought sequence and exhausting the designer.

Thus, since the commonly used two-dimensional GUIs present these obstacles in three-dimensional design, there is a need for a system that allows for easier manipulation and construction of three-dimensional digital designs and for easier modal selections.

These devices, which allow for easier spatial manipulation, can also be applied to entertainment. In particular, video games in arcades, on personal computers, and on consoles, to name a few locations, often involve the rapid and complex manipulation of spatial objects such as, and not limited to, characters (also known as avatars), weapons, projectiles, prizes, tools, puzzle pieces, enemies, and other objects that have value in a gaming scenario. These same devices can be used to create a new type of entertainment experience which extends and enhances gaming.

Thus, there is a need for a system that not only allows for easier manipulation and construction of both two and three-dimensional digital design, but also for easier manipulation and construction of both two and three-dimensional entertainment, for example, gaming.

### SUMMARY OF THE INVENTION

The present invention provides improved interface tools, both physical and digital for performing two and three-dimensional spatial manipulation and two and three-dimensional gaming. One embodiment of the invention is a set of three-dimensional multifunction tangible tools. These tools are shaped to specific forms. The forms mimic the tools' primary function, so the user gains an immediate intuition as to how each tool operates. For example, one of the tools is shaped to resemble a pair of kitchen tongs, which gives the user the immediate perception that they are to be used for grabbing. In addition, these tangible tools also have the advantage that they are able to be remapped to fulfill different functions.

Another embodiment of the invention is a methodology for using two physical or digital input devices in conjunction to alter two and three-dimensional virtual objects. For example, two grabbing tangible tools can be used together to alter the structure of one virtual object.

An additional embodiment of the invention is a methodology for associating physical components to two or three-dimensional virtual components. Note that a virtual component is a software representation of a physical component, and the software representation has a two or three-dimensional rendering associated with it. For example, a virtual component is a cursor on a computer screen. This methodology involves two concepts. A first concept involves the notion of being able to alter the relationship between a physical input methodology and its corresponding three-dimensional virtual components. A second concept involves various ways to map physical components to virtual components. According to another embodiment, the physical components are able to be mapped to one or more virtual components. According to another embodiment, this concept allows changing the type of two or three-dimensional virtual component(s) that is mapped to the physical component. For example, a user can change a physical component's virtual component representation from a spherical ball to a cube.

According to another embodiment, the invention presents several novel tools to alter and generate three-dimensional objects. Examples of these tools include a three dimensional eraser tool, which removes a region of a surface; a deformation tool, which is used to deform the geometry of a virtual object; a spray-painting tool, which is used to “spray” a three-dimensional virtual object with virtual paint; a smoothing tool, which is used to smooth the surface of a virtual object; and a texture creation tool, which is used to “spray” texture onto a three-dimensional virtual object.

According to another embodiment, the invention presents several novel means of interacting with video games using the tools mentioned above as a replacement for the standard joystick. For example, using the tool to grab things in space, to shoot, cut, place, rotate, and twist objects, to specify regions of space for the purposes of gameplay, drawing strokes in three-dimensional space as a component of gameplay, and using these tools for navigation of game-space in a variety of forms.

### BRIEF DESCRIPTION OF THE DRAWINGS

FIG. 1 illustrates three degrees of freedom of a generic rigid body in space.

FIG. 2 illustrates six degrees of freedom of a generic rigid body in space.

FIG. 3 is an illustration depicting a grabbing tangible tool, according to one embodiment of the present invention.

FIG. 4 is a flow chart showing the steps for checking for the position of a virtual component.

FIG. 5 is a flow chart showing the steps involved with activation of a virtual menu.

FIG. 6 is an illustration depicting a pointing tangible tool, according to one embodiment of the present invention.

FIG. 7 is an illustration depicting a gripping tangible tool, according to one embodiment of the present invention.

FIG. 8 is an illustration depicting the virtual menu of the gripping tangible tool, according to one embodiment of the present invention.

FIG. 9 is an illustration of the user moving the tool towards one icon of the virtual menu of the gripping tangible tool, according to one embodiment of the present invention.

FIG. 10 is an illustration depicting a user altering a virtual object with two pairs of grabbing tangible tools, according to one embodiment of the present invention.

FIG. 11 is an illustration depicting a user erasing a region of a virtual object with an erasing tool, according to one embodiment of the present invention.

FIG. 12 is an illustration depicting a user deforming a region of a virtual object with a deformation tool, according to one embodiment of the present invention.

FIG. 13 is a flow chart showing the steps for smoothing or texturizing a virtual object with the smoothing tool, according to one embodiment of the present invention.

FIG. 14 is an illustration depicting the before and after of a virtual object which has been smoothed by a smoothing tool, according to one embodiment of the present invention.

FIG. 15 illustrates a flowchart of a player using a grabbing tool along with a pointing tool to create a virtual three-dimensional solid curve or volume, according to one embodiment of the present invention.

FIG. 16 illustrates a flowchart of a player using 2 grabbing tools to rotate a virtual object in 3-D space, according to one embodiment of the present invention.

FIG. 17 illustrates a flowchart of a player using one or more grabbing tools and a gripping tool to place an object in 3-D space, according to one embodiment of the present invention.

FIG. 18 illustrates a flowchart of a player using a first grabbing tool to grab a second gripping tool's virtual component, according to one embodiment of the present invention.

FIG. 19 illustrates a flowchart of a player using two pointing devices to locate a point in 3-D space, according to one embodiment of the present invention.

FIG. 20 illustrates a flowchart of a player using a grabbing tool and a gripping tool to cut an object located far away from the player in 3-D space according to one embodiment of the present invention.

### DETAILED DESCRIPTION OF THE INVENTION

A method and an apparatus for using both physical and digital input methodologies to implement three-dimensional spatial manipulation and three-dimensional entertainment is described. In the following description, numerous details are set forth in order to provide a more thorough description of the present invention. It will be apparent, however, to one skilled in the art, that the present invention may be practiced without these specific details. In other instances, well known features have not been described in detail so as not to unnecessarily obscure the present invention.

Three-Dimensional Multifunction Tangible Tools

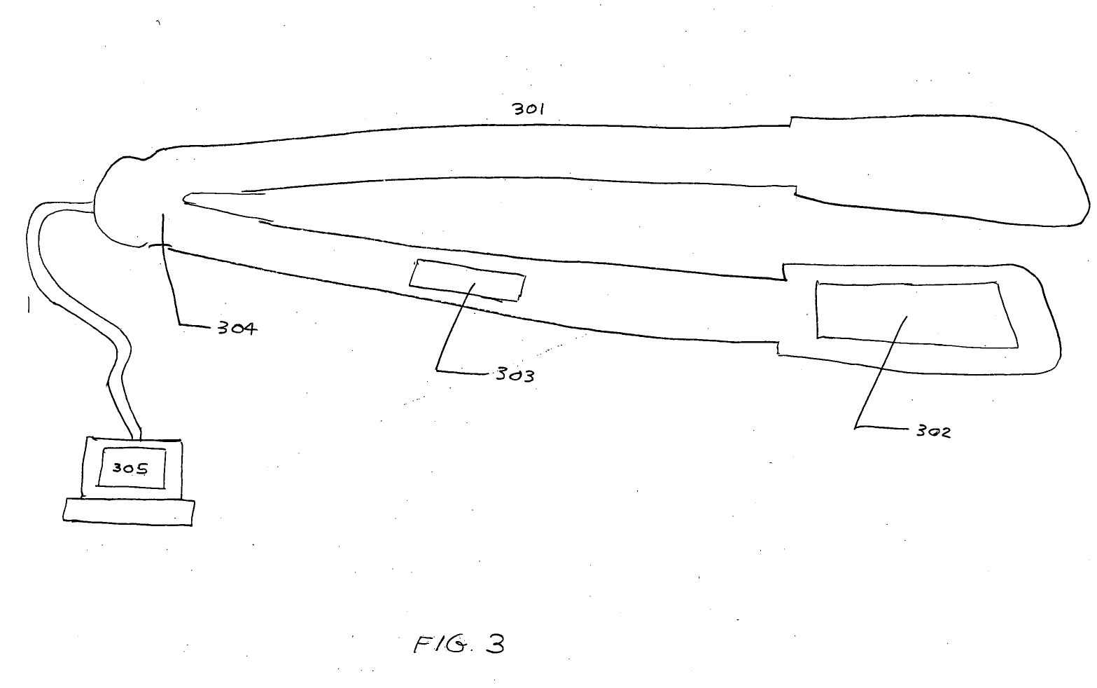

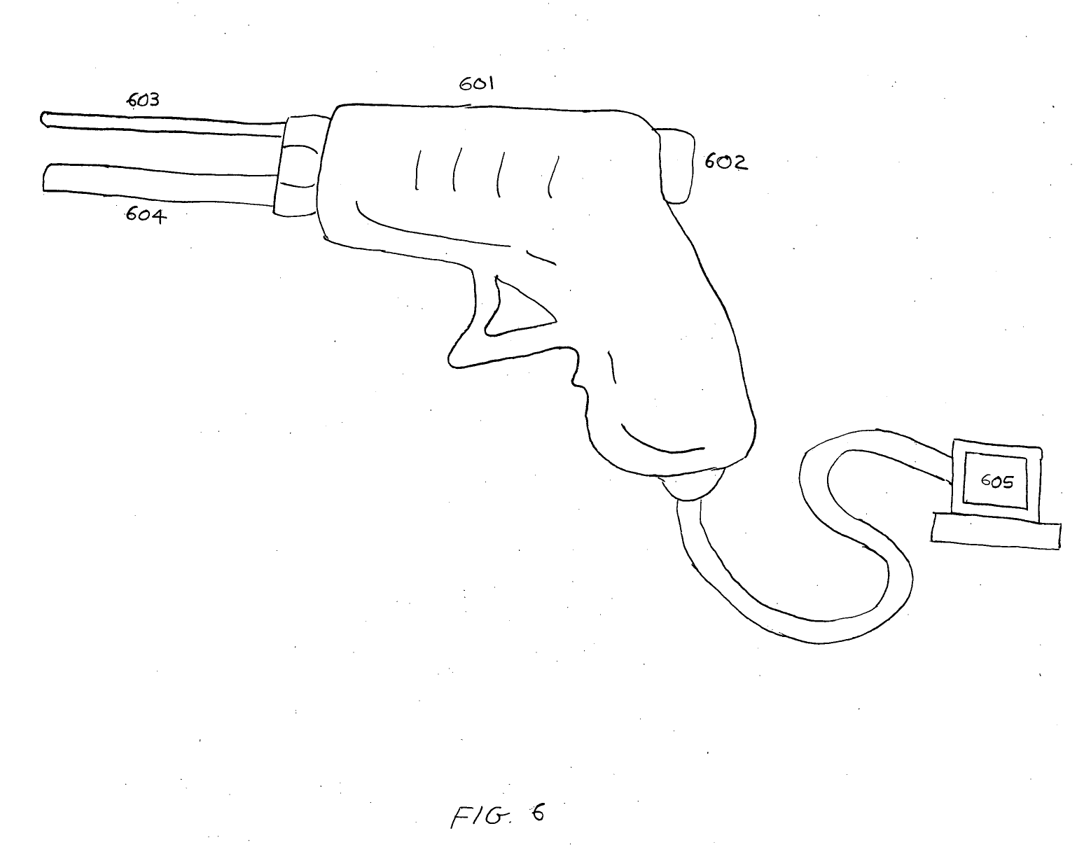

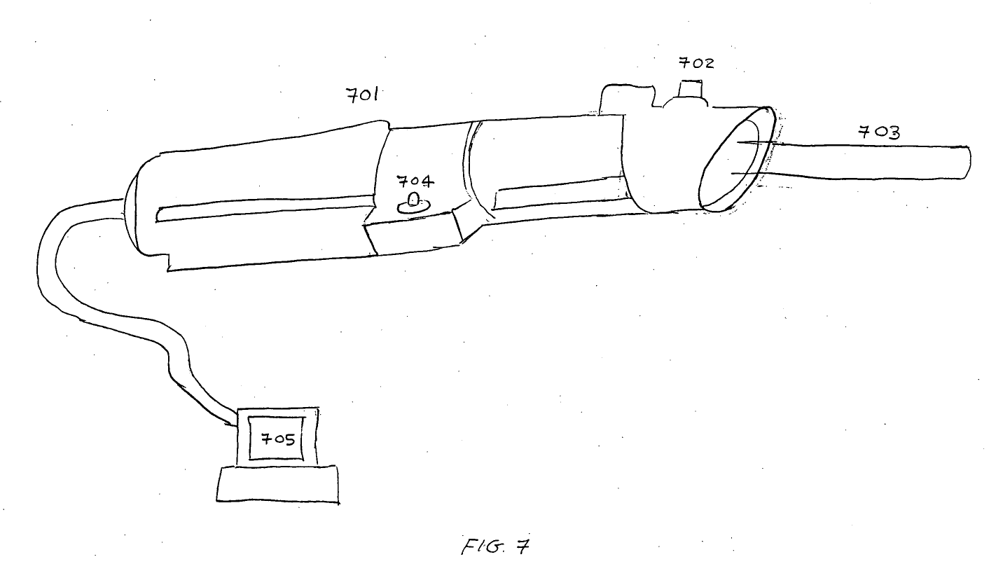

According to one embodiment, the present invention provides for using multifunction tangible tools to assemble and rearrange digital objects. Physical motions of the user are mapped to interface commands through these tools. These tools are connected to a computer which processes the motion data (see item 305 of FIG. 3, item 605 of FIG. 6, and item 705 of FIG. 7). These tools allow for the motions of the body to become a powerful mode of interaction with virtual reality (VR).

Using ordinary two-dimensional mouse interface tools to specify relative position and orientation of virtual objects in three-dimensional space is often difficult because the physical input methodology is of lower dimensionality than the task. The multifunction tangible tools of this embodiment solve this problem in that they allow for 6 or more DOF.

All of the various types of multifunction tangible tools specified in this embodiment can be constructed to control 6 or more DOF. There are several types of controlling that these tools can be manufactured to accommodate. The types of controlling are as follows:

Controlling a physical component's 1, 2, or 3-dimensional orientation in space.

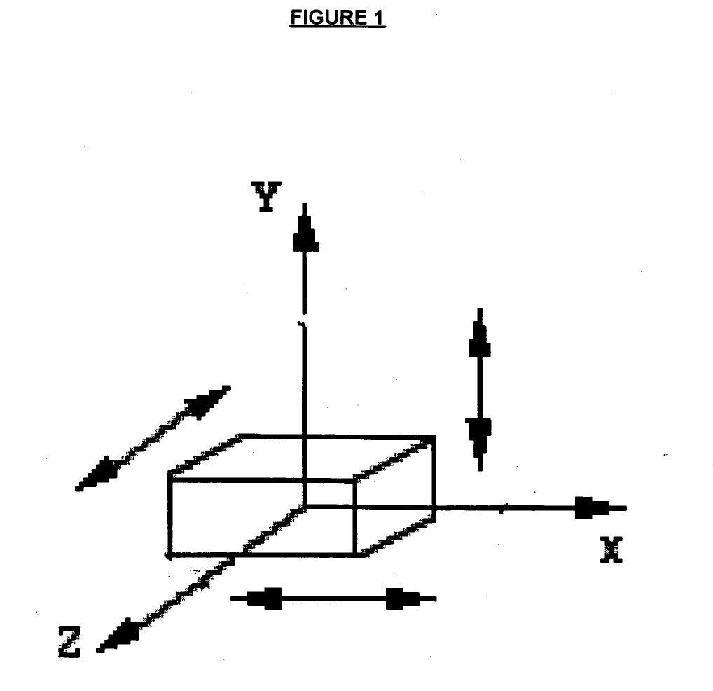

Controlling a physical component's position, without regard to the physical component's orientation: This controlling of position on the X, Y, and Z axis only is referred to as 3 DOF (See FIG. 1). In FIG. 1, the box represents a generic multifunction tangible tool. In this figure, the box's translating motions are along the X, Y, and Z axis.

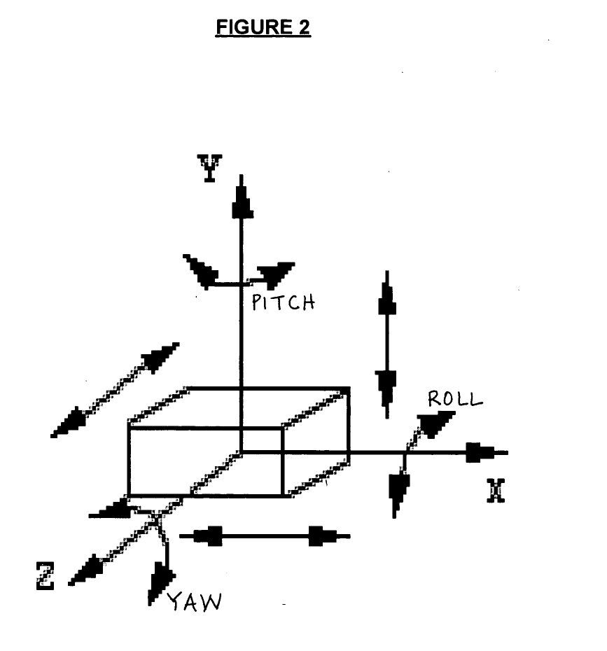

Controlling a physical component's position and orientation: This controlling of position on the X, Y, and Z axis along with controlling of rotation about the X, Y, and Z axis is referred to as 6 DOF (See FIG. 2). In FIG. 2, the box again represents a generic multifunction tangible tool. In this figure, the box's translating motions are along the X, Y, and Z axis and rotating motions are around the X, Y, and Z axis, respectively. These rotary motions are also commonly referred to as roll, pitch, and yaw about the X, Y, and Z-axis respectively.

According to another embodiment, the present invention is independent of the type of tracking technology that is used. Thus, any type of tracking technology can be implemented in the multifunction tangible tools of this embodiment. For example, types of tracking technology that can be used are magnetic, optical, acoustical, or inertial trackers. A desirable feature of this embodiment of the present invention is that a user is presented with tangible tools that have readily identifiable primary functions. This feature allows for a more spontaneous creation of three-dimensional virtual objects and a more intuitive gameplay because it creates a more perceptual relationship between the physical input methodology and its virtual product. These tools act like props (i.e. pseudo items which resemble genuine objects) because their physical components, and also sometimes their virtual components, are specifically shaped to mimic their primary functions.

For example, a tangible tool with its physical component shaped like a handle and its virtual component shaped like a sword's blade gives the user the intuitive impression that the tool is used for cutting or slicing, or a tool with its physical component shaped like a human hand and its virtual component shaped like a 3-dimensional paint brush gives the user the intuitive impression that the tool is used for painting. Thus, the physicality of these tangible tools allow the user to have an immediate familiarity with the tools' primary functions.

There is a provision of choices of physical forms that the multifunction tangible tools can have. Some examples of forms include, but not limited to, a physical form resembling a pair of tongs, a physical form resembling a gun, and a physical form resembling a handle (See FIGS. 3, 6, and 7). The physical form could also be any part of a human body. For example, a hand of a user wearing a glove can be used as a physical form, in which case the glove with sensors embedded in it is used to manipulate the hand's virtual component. Another example is a camera external to a hand shaped form used to manipulate the hand's virtual component. Yet another example is a device with infra-red capabilities external to a hand shaped form used to manipulate the hand's virtual component.

Grabbing Device

Item 301 in FIG. 3 shows one embodiment of a physical input methodology that is shaped to resemble a pair of kitchen tongs. Grabbing device 301 comprises of foil sensors 302 and 303, and a potentiometer 304. The grabbing device 301 is connected to computer 305. This tool's primary function, which mimics the form's real-life function, is to grab virtual objects. This grabbing tangible tool can be shaped to any physical form that resembles a set of tongs. A set of tongs is typically a grasping device consisting of two pieces joined at one end by a pivot or hinged like scissors. For example, the grabbing tool's form can resemble pincers, scissors, or tweezers.

The grabbing tangible tool's virtual form can be represented in a number of different ways. One way is that its virtual form can be represented by an iconic virtual component only, e.g., a spherical ball. Another way is that its virtual form can be represented by an iconic virtual component along with another virtual component that coincides with the tool's physical form, e.g., a spherical ball and a virtual pair of tongs. When a physical component is represented by two or more virtual components, the virtual components can be used to represent different things. For example, the virtual tongs can represent the position of the virtual component and the spherical ball can represent the axis of rotation of the tool. An additional way is that its virtual form can be represented by only a virtual component that coincides with the grabbing tangible tool's physical form, e.g., a virtual pair of tongs. Also, an alternative way is that its virtual form has no virtual depiction, i.e. it is neither represented by a virtual component nor a virtual object.

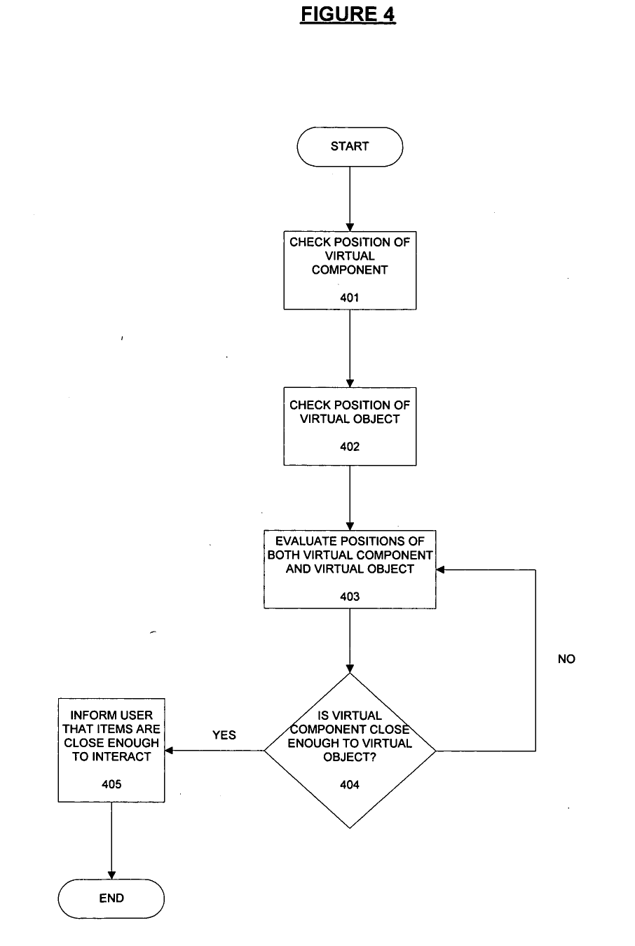

In another embodiment, in addition to any of the ways described above, when the grabbing tangible tool's virtual component is positioned near a virtual object, an iconic form will react to that virtual object. This notifies the user that the virtual component is close enough to the virtual object to interact with it. This iconic form may be represented, for example by the appearance of a virtual line drawn from the virtual object to the virtual component or by the virtual object itself turning a different color. The flow chart in FIG. 4 illustrates this process. At step 401, the position of the virtual component is contolled. Then, at step 402, the position of the virtual object is determined. Next, at step 403, the positions of both the virtual object and virtual components are evaluated. Next, at step 404, a check is made to see if both virtual items are close enough to interact with each other. If the items are (the “yes” branch), then at step 405, a virtual iconic form will appear, which notifies the user that the items are close enough to interact. If, on the other hand the items are not close enough (the “no” branch), then continue to evaluate their positions with respect to each other at step 403. Note that this process can be applied to any of the tangible tools or three-dimensional tools of this invention.

There are a number of ways of implementing controlling of the grabbing tangible tool's position. One way is to embed sensors inside the tongs themselves. These sensors can employ any available controlling technology, e.g., magnetic, optical, or inertial sensors. Another way is that the tongs are integrated into a controlling environment. For example, the tongs' physical component can be controlled by being viewed by a camera which tracks the tongs' position and/or orientation.

According to one embodiment, sensors are placed on the inside of the tips of the tongs, which are located furthest from the tongs' pivot location. As an example, sensors 302 in FIG. 3 have been implemented in the tips of a pair of tongs. These sensors sense whether the tongs are closed just enough for the tong tips to touch one another. We refer to this closed position as the primary position. Grabbing virtual objects with the tongs in the primary position can be used to signify a number of different things. For example, the interface can be implemented to understand that the user wants to move the entire virtual object that is being grabbed or it can be implemented to understand that the user wants to only move a portion of the virtual object that is being grabbed.

FIG. 3 shows another embodiment in which sensors 303 are also placed on the inside of the tongs closer to the tongs' pivot location. These sensors sense whether the tongs are closed so that the tong arms are adjacent to one another. We refer to this position as the secondary position. In an alternative embodiment, the controlling of how hard the tongs are being squeezed by the user can be achieved by the use of infra-red sensors embedded in the tong arms, pressure sensors embedded at the pivot location, a potentiometer 304 embedded at the pivot location, or by any other available controlling technology. Squeezing the tongs so that they are in the secondary position can be implemented to trigger certain additional functions. For example, some additional features could be a virtual menu, which exhibits a number of choices for the user to choose from; a shooting function, which shoots various types of virtual weapons; and a bomb function, which releases various types of virtual bombs.

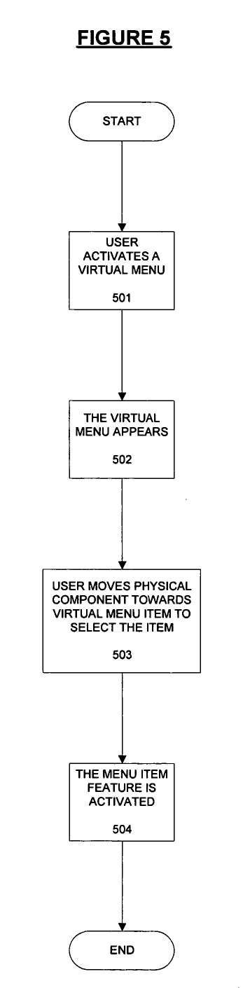

FIG. 5 is a flow chart illustrating the steps of selecting an item from a virtual menu. First, at step 501, the user activates a virtual menu. After activation, at step 502, the virtual menu appears. The user can then choose an item(s) displayed by the virtual menu by moving the physical component towards the virtual menu item(s), which is done at step 503. Once the virtual item(s) is selected, that item's feature is activated at step 504. This virtual menu item selection process can be utilized by any of the tangible tools or three-dimensional tools of this invention.

In addition, in another embodiment, the tongs may be manufactured to have additional controls which are used to activate additional features. For example, some types of controls could be buttons, joysticks, scroll wheels, foot pedals, or other sensors embedded in the device. Also, another type of control could consist of sensors embedded in the tool's stand, which is where the tool rests on when not in use. Thus, these sensors sense when the tool is being taken off its stand. These controls can be used to activate a number of various additional functions. For example, some functions could display a virtual menu consisting of a number of choices for the user to choose from, toggling between a “default” action mode and another type of action mode, shooting virtual weapons of various types, and releasing virtual bombs of various types.

Pointing Device

Item 601 in FIG. 6 shows one embodiment of a physical input methodology that is shaped to resemble a gun. Pointing device 601 comprises of virtual beams 603 and 604, and an additional button 602. The pointing device 601 is connected to computer 605. This tool's primary function, which mimics its form's real-life function, is to point to virtual objects. This pointing tangible tool can be shaped to any physical form that resembles a real-life object that is meant to point. For example, the pointing tool's form can resemble, and not limited to, any gun-like form, laser pointer, camera, pointing hand, stick, flashlight, or spray-paint can.

The specific primary function of a particular pointing tool can depend upon the tool's chosen physical form. For example, if the tool's physical form resembles a spray-paint can, the tool's specific primary function will be to spray paint of various colors onto three-dimensional virtual objects which the user points to with the tool. In another example, if the tool's physical form resembles a hot-glue gun, the tool's specific primary function will be to spray a stream of “glue” onto virtual objects, which will make the virtual objects appear more flexible, i.e. more rubbery, make the virtual components sticky, so that they stick to one another, or make the virtual objects just appear to be hotter in temperature, e.g., by turning the virtual objects red or orange in color.

Similar to the grabbing tangible tool, the pointing tangible tool's virtual form can also be represented in a number of different ways. The pointing device's virtual form can be represented by an iconic virtual component only, an iconic virtual component along with a virtual component that coincides with the tool's physical form, only a virtual component that coincides with the tool's physical form, or no virtual depiction at all. For example, the pointing device's iconic virtual component could be represented by a spherical ball and/or the pointing device's virtual component that coincides with the tool's physical form could be represented by either a laser beam or a stream of paint. In another embodiment, in addition to any of these ways, when the pointing tangible tool's virtual component is positioned near a virtual object, an iconic form, e.g., a virtual line drawn between the virtual object and the virtual component, reacts to that virtual object. This notifies the user that the virtual component is close enough to the virtual object to interact with it.

Like the grabbing tangible tool, there are a number of ways of implementing controlling the pointing tangible tool's position. One way is to embed sensors, which can employ any type of available controlling technology, inside the tool itself. Another way is to integrate the tool into a controlling environment. The various available controlling technologies mentioned above can be used to control the tool's position and/or orientation in the environment.

According to one embodiment, the pointing device's physical component is formed such that it has a trigger and sensors are placed inside of the trigger. These sensors can utilize any type of controlling technology, e.g., embedded magnetic, optical, or inertial sensors. These sensors will sense when the trigger is being pulled. Various types of functions can be mapped to the controlling of the trigger being pulled. For example, some functions could be shooting virtual objects, e.g., with virtual bullets or paint; pushing or pulling virtual objects, i.e. a tractor beam; slicing virtual objects using a cutting beam or laser beam that emits from the gun; and drawing connections between virtual objects, e.g., molecule bonds or architecture beams. FIG. 6 illustrates an example of two feature options which draws phosphate bonds represented by thin line 603, and draws hydrogen bonds represented by thick line 604. Note that this drawing is a composite picture showing both physical objects, for example pointing tangible tool 601 and computer 605, and virtual objects, for example laser beams 603 and 604. Also, in this embodiment, an additional function of property editing could be implemented to occur immediately after a particular function has occurred. For example, after the user has shot a virtual object, a virtual menu could be displayed to allow the user to choose certain properties of that particular virtual object.

Additionally, the pointing tangible tool's physical component can be manufactured to have additional controls which can be used to activate additional features. For example, just as with the grabbing tangible tool, some types of controls could be buttons, joysticks, scroll wheels, foot pedals, or other sensors that are embedded into the device itself. FIG. 6 shows an example of a pointing tangible tool with an additional action button 602. Also, another type of control could consist of sensors embedded in the tool's stand, which is where the tool rests on when not in use. These sensors sense when the tool is being taken off its stand. These controls can be used to activate a number of various additional functions. For example, some functions could be displaying a virtual menu consisting of a number of choices for the user to choose from, toggling between a “default” action mode and another type of action mode, shooting virtual weapons of various types, and releasing virtual bombs of various types.

Gripping Device

Item 701 in FIG. 7 shows one embodiment of a physical input methodology that is shaped to resemble a handle. Gripping device 701 comprises of additional buttons 702 and 704, and virtual beam 703. The gripping device 701 is connected to computer 705. This tool's primary function, which mimics its form's real-life function, is to hold, place, or cut virtual objects. This gripping tangible tool can be shaped to any physical form that resembles a real-life object that is meant to be gripped. For example, the gripping tool's form can resemble any handle-like form or grip, e.g., a sword handle, laser beam handle, or shovel handle.

The specific primary function of a particular gripping tool can depend upon the tool's chosen physical form. For example, if the tool's physical form resembles a sword handle, the tool's specific primary function will be to cut, slice, or puncture three-dimensional virtual objects. A sword handle could also have a specific primary function of breaking virtual bonds of virtual DNA molecules. In another example, if the tool's physical form resembles a shovel handle, the tool's specific primary function will be to dig out three-dimensional regions of a virtual object's surface. Additionally, a gripping tangible tool's specific primary function could be to place virtual objects in space or to draw paths between virtual objects.

Similar to both the grabbing tangible tool and the pointing tangible tool, the gripping tangible tool's virtual form can also be represented in a number of different ways. In these cases, the gripping tool is used to grab a virtual component which enables this action. The gripping device's virtual form can be represented by an iconic virtual component only, an iconic virtual component along with a virtual component that coincides with the tool's physical form, only a virtual component that coincides with the tool's physical form, or no virtual depiction at all. For example, the gripping device's iconic virtual component could be represented by a spherical ball and/or the gripping device's virtual component which coincides with its physical form could be represented by a finite laser beam, blade, or shovel head. See FIG. 7 for a depiction of an example of a gripping tangible tool's physical component 701 along with its finite laser beam virtual component 703. In another embodiment, in addition to any of these ways, when the pointing tangible tool's virtual component is positioned near a virtual object, an iconic form, e.g., a virtual line drawn between the virtual object and the virtual component, will react to that virtual object. This notifies the user that the virtual component is close enough to the virtual object to interact with it.

Like the grabbing tangible tool and the pointing tangible tool, there are a number of ways of implementing controlling of the gripping tangible tool's position. One way is to embed sensors, which can employ any type of available controlling technology, inside the tool itself. Another way is to integrate the tool into a controlling environment. Various available controlling technologies can be used to control the tool's position and/or orientation in the environment.

In addition, in another embodiment, the gripping tangible tool may be manufactured to have additional controls, which are used to activate additional features. For example, some types of controls could be buttons, joysticks, scroll wheels, foot pedals, or other sensors embedded in the device. Example additional buttons 702 and 704 are depicted in FIG. 7. Also, another type of control could consist of sensors embedded in the tool's stand, which is where the tool rests on when not in use. Thus, these sensors sense when the tool is being taken off its stand. Additionally, another type of control can consist of sensors, which are embedded inside the device that sense when the gripping tool is being held by a user.

All of these above mentioned controls can be used to activate a number of various additional functions. For example, some functions could be changing the length of the virtual blade/beam, displaying a virtual menu consisting of a number of choices for the user to choose from, toggling between a “default” action mode and another type of action mode, shooting virtual weapons of various types, and releasing virtual bombs of various types.

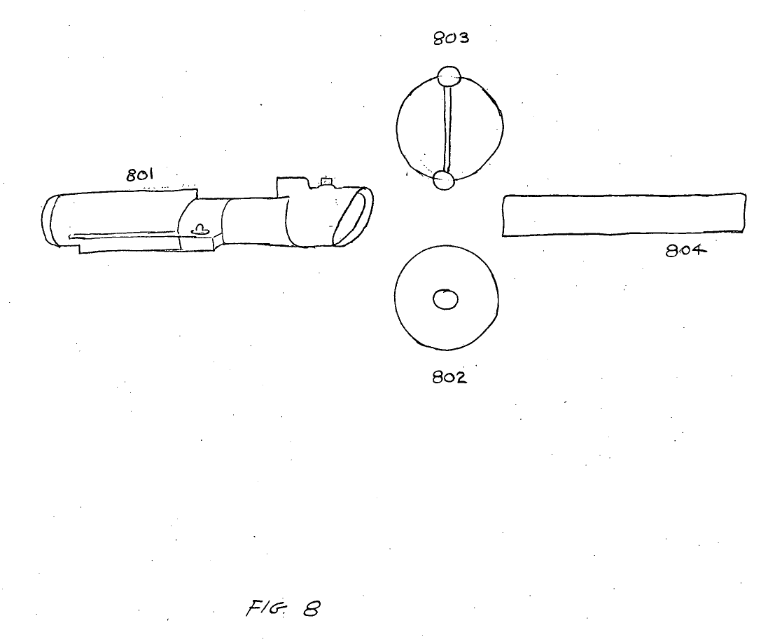

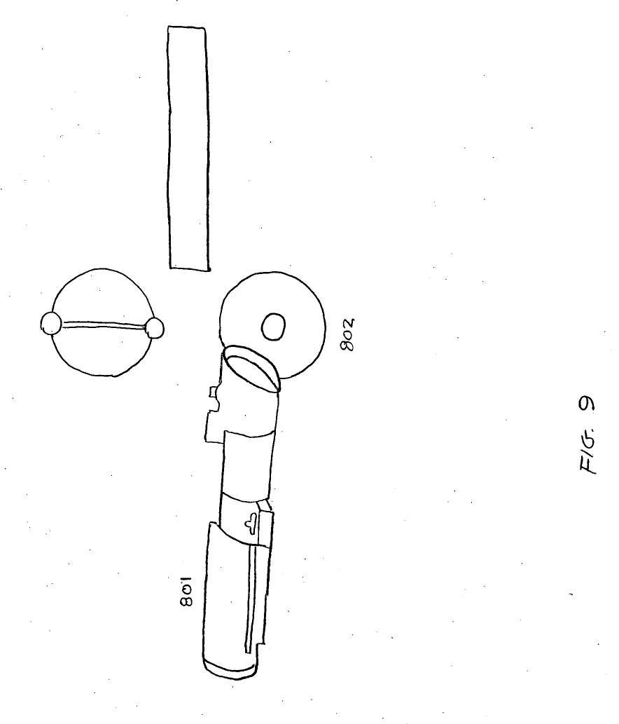

FIG. 8 shows an example of a gripping tangible tool 801 with a DNA creation virtual menu that has been activated. FIG. 8 is a composite picture showing both a physical object, gripping device 801, and a virtual object. The virtual object comprises a virtual menu comprising of virtual menu icons 802 and 803, and a finite laser beam 804. This virtual menu presents the user with various options for creating virtual DNA molecules. In this example, the single-dot icon 802 of the virtual menu activates a single-strand drawing, the double-dot icon 803 of the virtual menu activates a double-helix drawing, and the line 803 of the virtual menu represents the finite laser beam, which is used to break virtual bonds. FIG. 9 illustrates the user selecting the single-strand drawing option 802 by moving the physical component 801 towards the single-strand drawing virtual menu item.

Methodology for Using two or More Physical Input Devices in Conjunction to Alter two or Three-Dimensional Virtual Objects

The present invention provides for using two or more physical input methodologies in conjunction to manipulate and construct two or three-dimensional digital objects. These physical input methodologies can consist any type of two or three-dimensional GUI, including any of the various types of multifunction tangible tools which have been specified in the previous section.

Two-Handed Drawing of Virtual Objects Using two or More Physical Input Methodologies

According to one embodiment of the present invention, it is possible for a user to use two or more physical input methodologies coincidently to draw virtual objects. Various types of physical input device tools may be utilized for this feature of the present invention.

For example, a user can use a grabbing tangible tool input device along with a pointing tangible tool input device to create a virtual three-dimensional solid curve or volume. This example employs a grabbing tangible tool formed to resemble a pair of kitchen tongs and a pointing tangible tool formed to resemble a gun. In this example, the user uses the tongs to grab the gun's virtual object—an emanating beam. The user then bends the virtual beam with the tongs. Once the beam is bent, the user sweeps the pointing tangible tool in space. This sweeping action causes a three-dimensional virtual solid curve to be created. If alternatively the user sweeps the beam so that the curve is closed, a three-dimensional volume is generated.

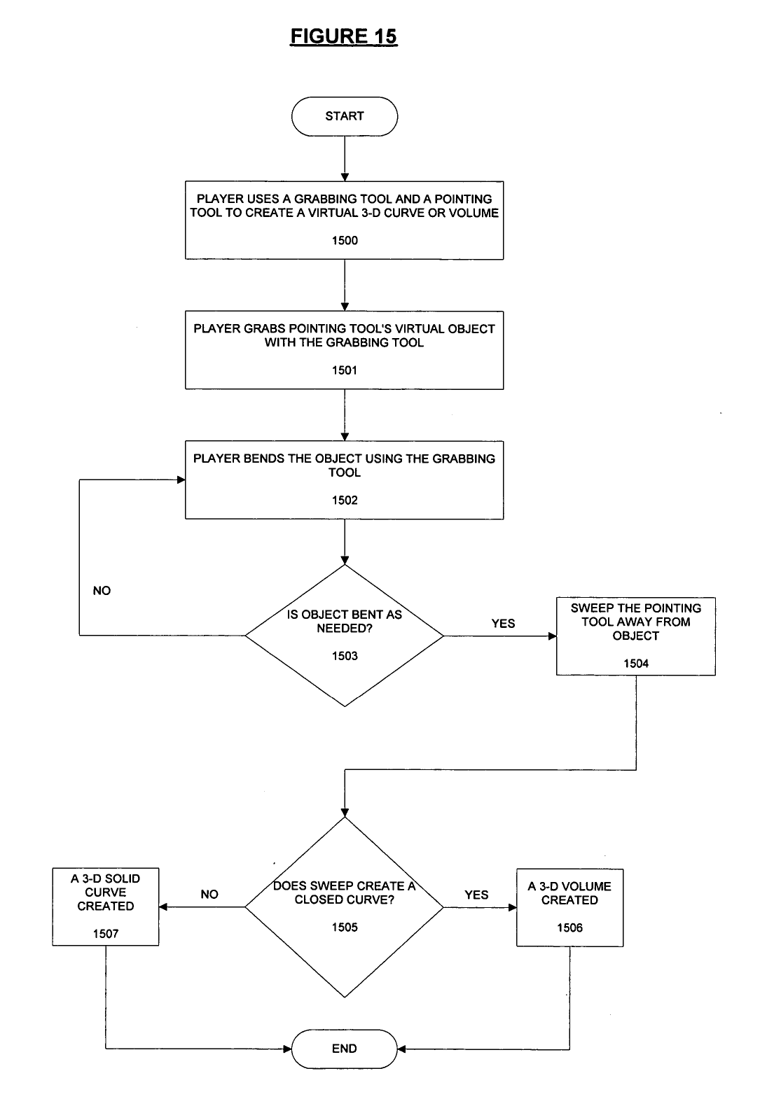

FIG. 15 illustrates a flowchart of a player using a grabbing tool along with a pointing tool to create a virtual three-dimensional solid curve or volume. At step 1500, a player uses a grabbing tool and a pointing tool to create a virtual three-dimensional curve or volume. At step 1501, the player grabs the pointing tool's virtual object with the grabbing tool. Next, at step 1502, the player bends the object using the grabbing tool. Next, at step 1503, a check is made to see if the virtual object is bent as needed. If the virtual object is not bent as needed (the “no” branch), then the player continues to bend the object at step 1502. If, on the other hand, the object is bent as desired (the “yes” branch), then at step 1504, the pointing tool is swept away from the object. Next, at step 1505, another check is made to see if the sweeping action of step 1504 creates a closed curve. If it does (the “yes” branch), then at step 1506, a three-dimensional volume is created. If, on the other hand, the curve is not closed (the “no” branch), then at step 1507, a three-dimensional solid curve is created.

According to another example, a user can use a grabbing tangible tool input device, a pointing tangible tool input device, and a gripping tangible tool input device to assemble and rearrange virtual molecules. In this example, the user first uses the gripping tangible tool's additional function of double-helix drawing to construct virtual DNA molecules. Once the virtual DNA molecules are constructed, the user can then use the pointing tangible tool to draw the DNA's phosphate bonds and hydrogen bonds. The user may use one or more grabbing tangible tools to move the virtual DNA to a position that allows for easier drawing of the bonds. Then, if the user desires, the user can use the gripping tangible tool to break any of the virtual DNA bonds.

Two-Handed Placement of a Virtual Object in two or Three-Dimensional Space

According to another embodiment of the present invention, it is possible for a user to use two or more physical input methodologies coincidently to change the placement of virtual objects in two or three-dimensional space. Various types of physical input methodology tools may be utilized for this feature of the present invention.

For example, a user can use two grabbing tangible tool input devices to rotate a virtual object in three-dimensional space. This example employs two grabbing tangible tools which are formed to resemble a pair of kitchen tongs. Here, the user just simply uses the two tools to grab the two extreme ends of the virtual object. Once the virtual object is grabbed, the user then rotates the virtual object to a desired position in space.

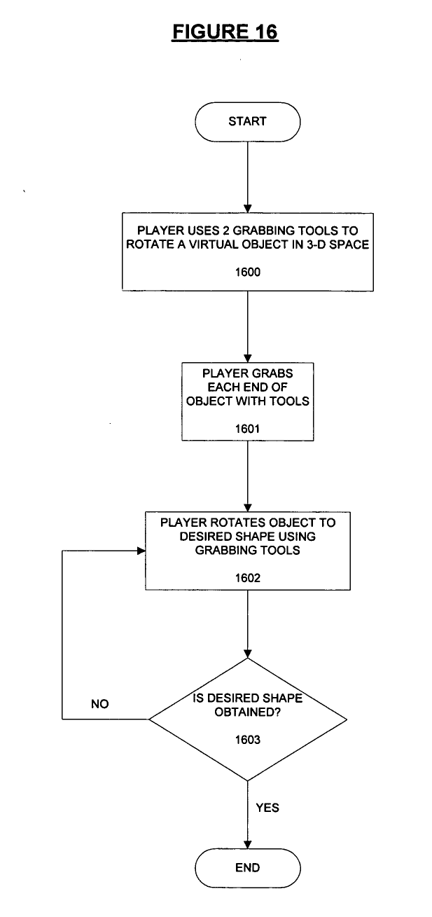

FIG. 16 illustrates a flowchart of a player using 2 grabbing tools to rotate a virtual object in 3-D space. At step 1600, the player uses two grabbing tools to rotate a virtual object in 3-dimensional space. At step 1601, the player grabs each end of object with the grabbing tools. Next, at step 1602, the player rotates the object to a desired shape using the grabbing tools. Next, at step 1603, a check is made to see if the object is rotated to the desired shape. If, it is not (the “no” branch), then the player goes back to step 1602 and continues to rotate the object, else (the “yes” branch) the player stops.

In another example, the user can use one or more grabbing tangible tool input devices along with one gripping tangible tool input device to place a virtual object to a desired position in space. This example employs a grabbing tangible tool which is formed to resemble a pair of kitchen tongs and a gripping tangible tool which is formed to resemble a finite laser beam. In this example, the user first uses one or more grabbing tangible tools to rotate the virtual object to a desired position. Once the virtual object is rotated such that the virtual object's desired view is facing the user, the user can then use the gripping tangible tool to place the virtual object in a desired location in space.

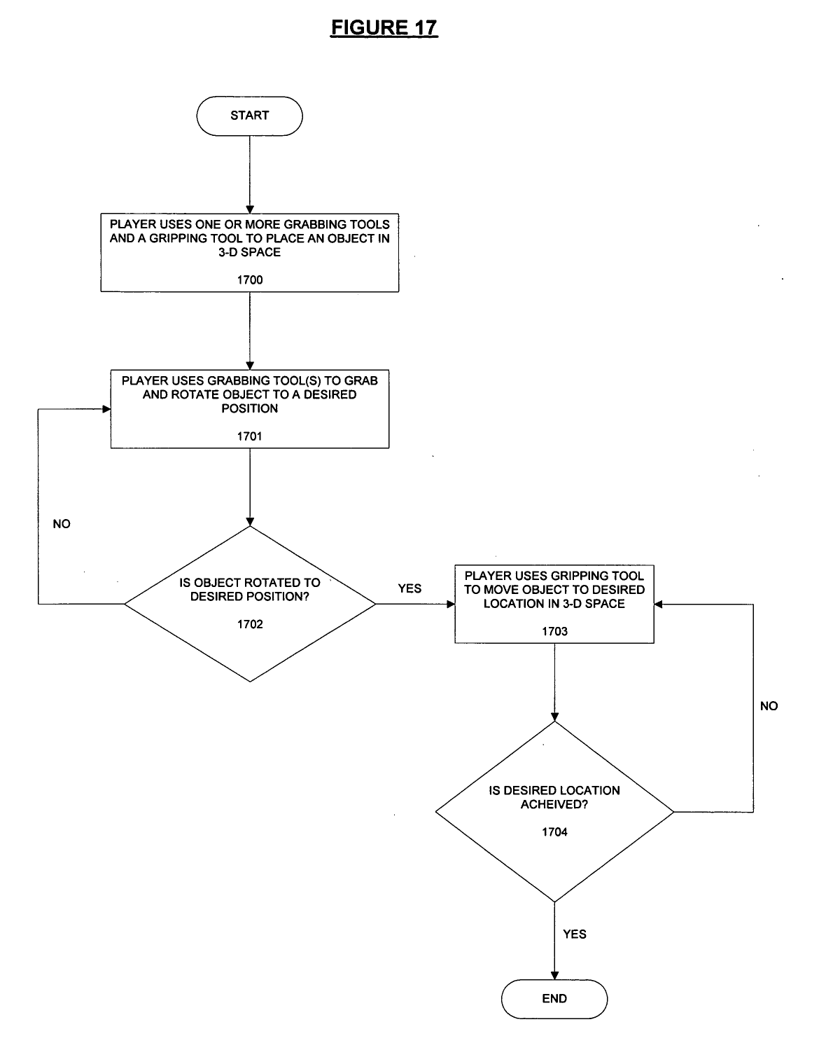

FIG. 17 illustrates a flowchart of a player using one or more grabbing tools and a gripping tool to place an object in 3-D space. At step 1700, a player uses one or more grabbing tools in conjunction with a gripping tool to place an object in 3-dimensional space. At step 1701, the player uses the grabbing tool(s) to grab and rotate object to a desired position in space. Next, at step 1702, a check is made to see if the object has been rotated to its desired position. If not (the “no” branch), then the player goes back to rotating the object at step 1701. If, on the other hand, the object has been rotated to its desired location (the “yes” branch), then at step 1703 the player uses the gripping tool to move the object to the desired location in the 3-dimensional space. Next, at step 1704, another check is made to see if the object has been moved to its desired location. If it is not (the “no” branch), then the player continues to move the object at step 1703, else (the “yes” branch) the player stops.

Two-Handed Deforming of a Virtual Object

According to another embodiment of the present invention, it is possible for a user to use two or more physical input methodologies coincidently to deform virtual objects. Various types of physical input methodology tools may be utilized for this feature of the present invention.

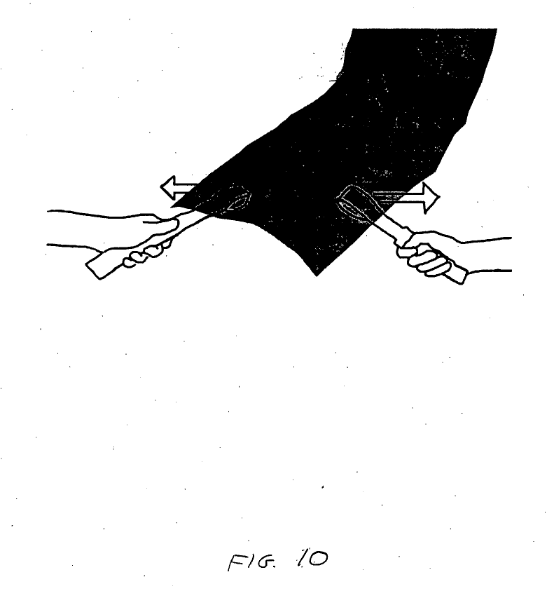

For example, a user can use two grabbing tangible tool input devices to stretch a virtual object. FIG. 10 illustrates a user using two grabbing tangible tools, which are formed to resemble kitchen tongs, to stretch the sides of a virtual solid three-dimensional curve. Note that this drawing is a composite picture showing both physical objects, a user holding two grabbing tangible tools, and virtual objects, a virtual solid curve and two arrows (one towards the right of the Figure and one towards the left of the Figure) denoting the directions that the user is pulling the surface.

In an additional example, a user can use two grabbing tangible tool input devices to twist a virtual object. Similar to the previously mentioned example, the user can use two grabbing tangible tools to twist a virtual object to a desired shape.

Two-Handed Remapping of Tools

According to another embodiment of the present invention, it is possible for a user to use two or more physical input methodologies to alter one physical input device's virtual component. Various types of physical input device tools may be utilized for this feature of the present invention.

For example, a user can use one grabbing tangible tool input device to modify the axis of rotation of another grabbing tangible tool input device. This example employs two grabbing tangible tools which are both formed to resemble a pair of kitchen tongs. In this example, the user uses the first grabbing tangible tool to grab the second grabbing tangible tool's virtual component, which is shaped like a spherical ball. This virtual component defines the axis of rotation for the second grabbing tangible tool. Then, the user uses the first grabbing tangible tool to move the virtual component to a desired location in relationship to the second grabbing tangible tool. Once the virtual component is positioned to a desired location, the user can then use the second grabbing tangible tool to rotate a virtual object.

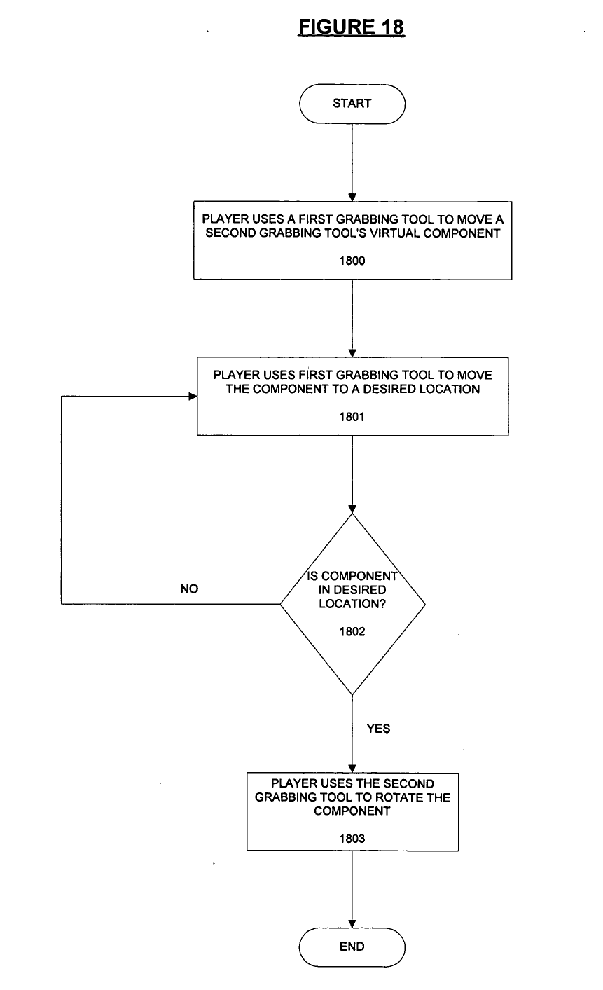

FIG. 18 illustrates a flowchart of a player using a first grabbing tool to grab a second gripping tool's virtual component. At step 1800, a player uses a first grabbing tool to grab onto a second grabbing tool's virtual component. At step 1801, the player uses the first grabbing tool to move the component of the second grabbing tool to a desired location. Next, at step 1802, a check is made to see if the component is in the desired location. If it is not (the “no” branch), then the player continues to move the component at step 1801. If, on the other hand, the object is moved to its desired location (the “yes” branch), then at step 1803, the player uses the second grabbing tool to rotate the object.

Two-Handed Definition of a Point in Three-Dimensional Space

According to another embodiment of the present invention, it is possible for a user to use two or more physical input methodologies coincidently to specify a point in two or three-dimensional space. Various types of physical input methodology tools may be utilized for this feature of the present invention.

For example, a user can use two pointing tangible tool input devices to specify a point in two or three dimensional space. This example employs two pointing tangible tools, each of which is formed to represent a gun. There are a couple of ways that these tools' virtual objects can be formed for this example. In one way, each pointing tangible tool has a virtual object that is formed to resemble a laser beam. In this example, the user physically positions the tools such that their virtual beams intersect. The intersection of these two virtual beams denotes a point in space. In another way, only one pointing tangible tool has a virtual object that is formed to resemble a laser beam and, alternatively, the other pointing tangible tool has a virtual object that is formed to resemble a solid plane emanating from the barrel of the gun. Similar to the prior example, the user physically positions the tools such that the virtual beam intersects the virtual plane. The intersection of the virtual beam and virtual plane signifies a point in space.

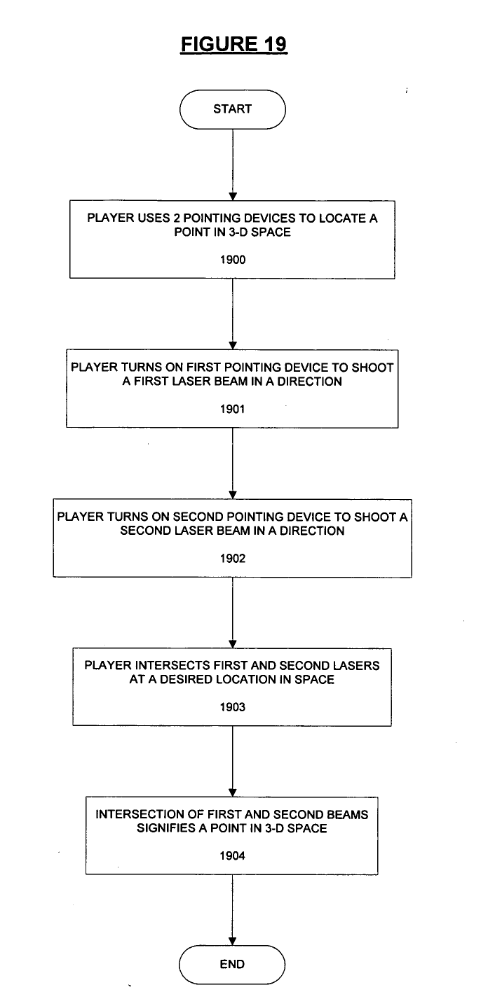

FIG. 19 illustrates a flowchart of a player using two pointing devices to locate a point in 3-D space. At step 1900, a player uses 2 pointing devices to locate the position of a point in 3-dimensional space. At step 1901, the player turns on the first pointing device to shoot a first laser beam in a desired direction. Next, at step 1902, the player turns on a second pointing device to shoot a second laser beam in a desired direction. Next, at step 1903, the player intersects first and second lasers at a desired location in 3-D space. Finally, at step 1904, the intersection of the two lasers signifies a point in 3-D space.

Methodology for Associating Physical Components to two or Three-Dimensional Virtual Components

The present invention provides for altering the association between a physical input methodology's physical component and its corresponding two or three-dimensional virtual component(s). This feature allows for more flexibility in creating virtual objects.

Displacing Virtual Component from Physical Component

According to one embodiment of the present invention, it is possible for a user to use one physical input methodology to alter the spatial relationship between another physical input methodology and its corresponding virtual component. Various types of physical input methodology tools may be utilized for this feature of the present invention.

Consider an example where a user wants to cut a virtual object that is located far from the user. To make this task easier, the user can use a grabbing tangible tool input device to lengthen the virtual component of a gripping tangible tool input device. In this example, the specific primary function of the gripping tangible tool's virtual component is to cut. This example employs a grabbing tangible tool which is shaped to resemble a pair of kitchen tongs and a gripping tangible tool which is shaped to resemble a finite laser beam handle. In this example, the user uses the grabbing tangible tool to grab the gripping tangible tool's virtual component, which is formed to resemble a finite laser beam. The user then uses the grabbing tangible tool to pull the virtual beam until it reaches a desired length. Once the desired beam length is achieved, the user can then use the gripping tangible tool to cut the far away virtual object.

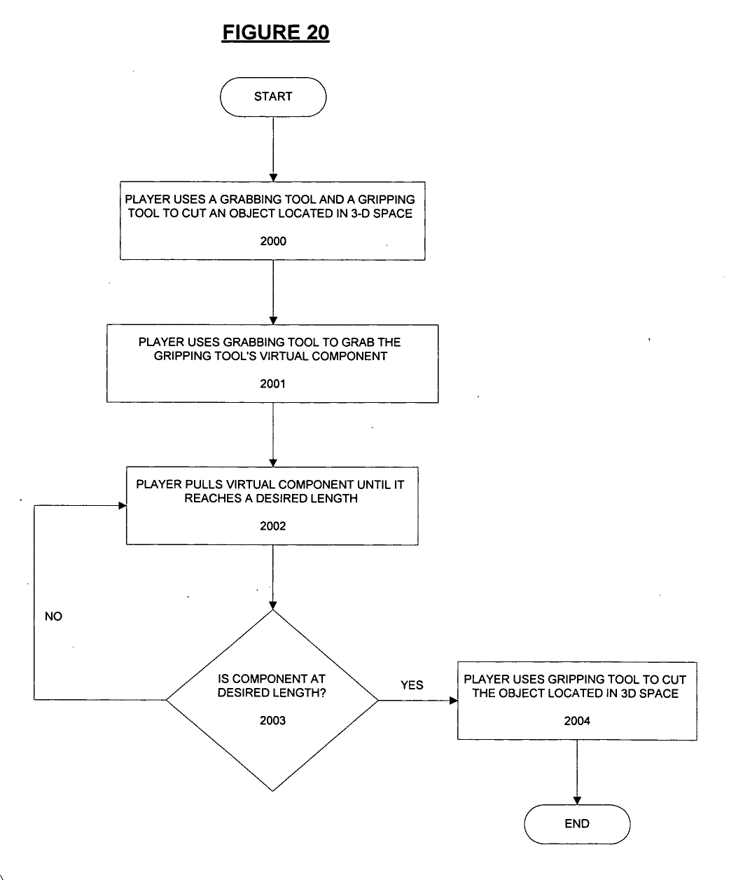

FIG. 20 illustrates a flowchart of a player using a grabbing tool and a gripping tool to cut an object located far away from the player in 3-D space. At step 2000, the player uses a grabbing tool and a gripping tool to cut an object in 3-D space. At step 2001, the player uses the grabbing tool to grab the gripping tool's virtual component. Next, at step 2002, the player pulls the component until it reaches a desired length. Next, at step 2003, a check is made to see if the component is stretched to the desired length. If it is not (the “no” branch), then the player continues to stretch the component at step 2002. If, on the other hand, the desired length of the component is reached (the “yes” branch), then at step 2004, the player uses the gripping tool to cut the object.

Physical Component is Mapped to Multiple Virtual Components

According to another embodiment of the present invention, it is possible for a user to map multiple virtual components to one physical component. In this feature, the user has the option to map one or more virtual components to a single physical component. This option can be presented to the user in a variety of ways. For example, this mapping option can be on a virtual menu, which can be activated by the user via an additional control on the physical input device.

Change Which Type of Virtual Component is Mapped to the Physical Component

According to another embodiment of the present invention, it is possible for a user to change the type(s) of virtual component(s) that is mapped to one physical component. For example, a user can change a physical input device's virtual component from a spherical ball representation to a solid cube representation.

In this feature, the user is able to select the type of virtual component(s) that is to be mapped to one physical component. This option can be presented to the user in a variety of ways. For example, this mapping option can be on a virtual menu, which can be activated by the user via an additional control on the physical input device.

Three-Dimensional Virtual Tools

According to one embodiment of the present invention, a number of various three-dimensional virtual tools can be provided to a user. These tools allow the user to create three-dimensional digital depictions of a design idea with greater ease.

The use of commonly used two-dimensional GUIs to perform these three-dimensional tasks requires the designer to do much planning of the construction process in order to achieve a desired shape. This is because typical two-dimensional GUIs only control 2 DOF. Like the multifunction tangible tools, the three-dimensional GUIs presented in this embodiment can be manufactured to control 6 or more DOF. The controlling of 6 or more DOF, allows for more intuitive connection between a designer's movements of the GUI and the three-dimensional virtual product. Thus, in contrast to typical two-dimensional GUIs, these three-dimensional GUIs are better able to capture the designer's gesture, emotion, and spontaneity.

The three-dimensional virtual tools of this embodiment can be shaped to any physical form. For example, these tools may be formed to resemble specific commonplace items or may be formed into amorphous ergonomic shapes that fit comfortably in the user's hand.

Similar to the multifunction tangible tools, the virtual form of any of the three-dimensional virtual tools in this embodiment can be represented in a number of different ways. The virtual form can be represented by an iconic virtual component only, an iconic virtual component along with a virtual component that resembles the tool's physical form, only a virtual component that resembles the tool's physical form, or no virtual depiction at all. For example, an iconic virtual component could be represented by a spherical ball. In another embodiment, in addition to any of these ways, when the virtual component of any of these tools is positioned near a virtual object, an iconic form, e.g., a virtual line drawn between the virtual object and the virtual component, will react to that virtual object. This notifies the user that the virtual component is close enough to the virtual object to interact with it.

There are a number of ways of implementing controlling the position of the three-dimensional virtual tools of this embodiment. One way is to embed sensors, which can employ any type of available controlling technology, inside the tool itself. Another way is to integrate the tool into a controlling environment. Various available controlling technologies can be used for this way to control the tool's position and/or orientation in the environment. For example, types of tracking technology that can be used, and not limited to, are magnetic, optical, acoustical, or inertial trackers.

According to another embodiment, other types of controlling can be employed in the three-dimensional virtual tools. One type of controlling could consist of sensors embedded in the tool's stand, which is where the tool rests on when not in use. Thus, these sensors sense when the tool is being taken off its stand. Another type of controlling can consist of sensors, which are embedded inside of the device that sense when the tool is being held by a user. All of the above mentioned different types of controlling can be used to activate a number of various functions.

Eraser Tool

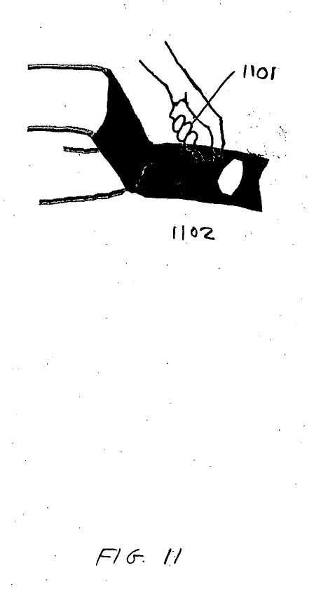

According to one embodiment, the three-dimensional virtual tool of the present invention is an eraser tool. This tool's primary function, similar to its real-life function, is to erase three-dimensional regions of virtual objects. Once a virtual drawing has been made, a user can remove portions of the drawing by waving the eraser tool on the areas of the virtual object that the user wants to erase. The size of the three-dimensional region that the eraser removes can be set to a default predetermined size. FIG. 11 shows a user using an eraser tool 1101 to erase a three-dimensional region (the region is depicted as a white region over a gray three-dimensional region) of a virtual object 1102 that is shaped to resemble a chair. Note that this illustration is a composite picture showing both physical objects, the user holding an eraser tool 1101, and a virtual object, a virtual chair 1102.

According to one embodiment, the eraser tool's physical component can be manufactured to have additional controls which can be used to activate additional features. For example some types of controls could be, and not limited to, buttons, joysticks, scroll wheels, foot pedals, or other sensors that are embedded into the methodology itself. The other sensors that are embedded in the methodology itself could be used to control, for example, when the user applies pressure to a device with a thumb. These additional controls can be used to activate a number of various additional functions. For example, some additional functions could be changing the size of the default erasing region or displaying a virtual menu consisting of a number of choices from which the user can choose. Another function could be toggling between a “default” erasing mode and another type of erasing mode. In this example, the “default” erasing mode could set the eraser to erase a default region size and the other type of erasing mode could set the eraser to erase a user-specified region size.

Deformation Tool

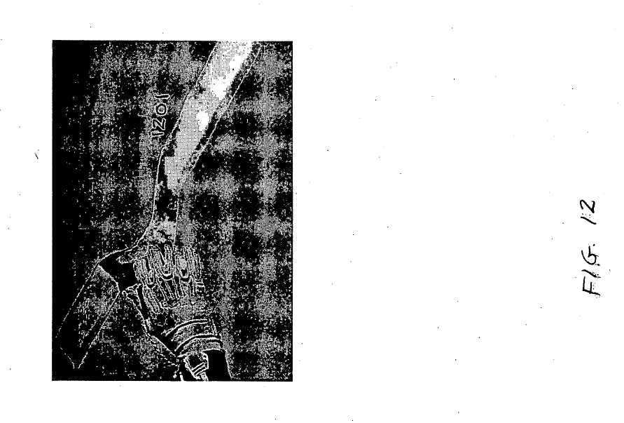

According to another embodiment, the three-dimensional virtual tool of the present invention is a deformation tool. This tool's primary function is to deform regions of three-dimensional virtual objects. This tool allows a user to deform portions of a virtual object by waving the deformation tool close to or on areas of the virtual object that the user wants to deform. If the user waives the tool near the virtual object without touching the virtual object, the area of the virtual object that the deformation tool is near will pull upward towards the tool. Conversely, if the user waives the tool on an area of the virtual object, the area of the virtual object that the deformation tool touches will push away from the tool. The amount of deformation of the virtual object is dependent upon how far away from the virtual object the user positions the tool or how deeply into the virtual object the user waives the tool. FIG. 12 shows a user using a deformation tool to deform a three-dimensional virtual object 1201. In this figure, the user is positioning the deformation tool such that the virtual object 1201 is being depressed by the tool. Note that this illustration is a composite picture showing both physical objects, the user holding a deformation tool, and a virtual object 1201.

According to another embodiment, similar to the eraser tool, the deformation tool's physical component can be manufactured to have additional controls which can be used to activate additional features. For example some types of controls could be buttons, joysticks, scroll wheels, foot pedals, or other sensors that are embedded into the methodology itself. The other sensors that are embedded in the methodology itself could be used, for example, to sense when the user applies pressure to a device with his thumb. These additional controls can be used to activate a number of various additional functions. For example, some functions could be changing the sensitivity of deformation, i.e. how much deformation per unit of tool movement; displaying a virtual menu consisting of a number of choices from which the user can choose; or toggling between a “default” action mode and another type of action mode.

Smoothing Tool

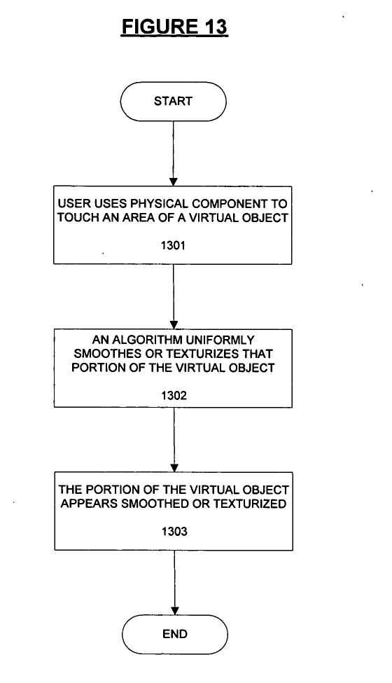

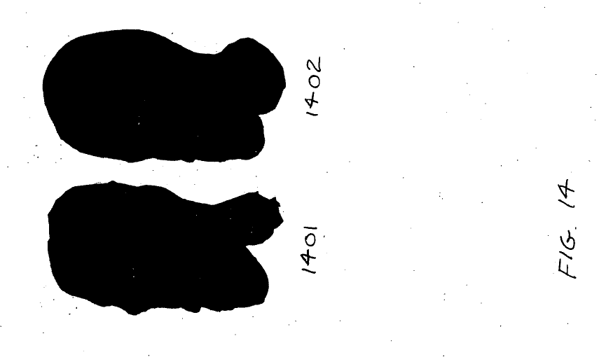

According to another embodiment, the three-dimensional virtual tool of the present invention is a smoothing tool. This tool's primary function is to smooth or texturize regions of three-dimensional virtual objects. This tool allows a user to smooth or texturize portions of a virtual object by waving the smoothing tool on areas of the virtual object that the user wants to smooth or texturize. The size of the three-dimensional region that the smoother tool smoothes or texturizes can be set to a default predetermined size. The tool uses an algorithm to uniformly smooth or texturize a selected area of a virtual object. FIG. 13 illustrates the smoothing or texturizing process that the smoothing tool undergoes. First, at step 1301, the user uses the physical component to touch an area of a virtual object that is to be smoothed or texturized. Once, a region of a virtual object is touched with the physical component, then at step 1302 an algorithm uniformly smoothes or texturizes the touched portion of the virtual object. Then, at step 1303, the region of the virtual object will appear to be smoothed or texturized. FIG. 14 shows a digital illustration of two three-dimensional virtual drawings of a human head. Head 1401 depicts a virtual head before being smoothed by the smoothing tool, and head 1402 depicts a virtual head after being smoothed by the smoothing tool.

According to one embodiment, the smoother tool's physical component can be manufactured to have additional controls which can be used to activate additional features. For example some types of controls could be, and not limited to, buttons, joysticks, scroll wheels, foot pedals, or other sensors that are embedded into the methodology itself. The other sensors that are embedded in the methodology itself could be used to control, for example, when the user applies pressure to a device with a thumb. These additional controls can be used to activate a number of various additional functions. For example, some functions could be changing the size of the default smoothing region, changing the degree of smoothing or texturizing the tool will perform, or displaying a virtual menu consisting a number of choices from which the user can choose. Another function could be toggling between a “default” action mode and another type of action mode. In this example, the “default” action mode could set the smoother to smooth mode and the other type of action mode could set the smoother to texturize mode. Alternatively, in this example, the “default” action mode could set the smoother to smooth or texturize a default region size and the other type of action mode could set the smoother to smoother or texturize a user-specified region size.

Painting Tool

According to another embodiment, the three-dimensional virtual tool of the present invention is a spray-painting tool. This tool's primary function is to spray various colors of virtual paint onto regions of three-dimensional virtual objects. This tool allows a user to spray paint a portion of a virtual object by pointing the spray-painting tool to the area of the virtual object that the user wants to paint. The size of the three-dimensional region of the virtual object that the spray-painting tool covers with paint is dependent upon the distance the user holds the tool from the virtual object. The rate of flow of paint being sprayed by the spray-painting tool is set to a default predetermined setting.

In one embodiment, the spray-painting tool's physical component can be manufactured to have additional controls which can be used to activate additional features. For example some types of controls could be buttons, joysticks, scroll wheels, foot pedals, or other sensors that are embedded into the methodology itself. The other sensors that are embedded in the methodology itself could be used to sense, for example, when the user applies pressure to a device with a thumb. These additional controls can be used to activate a number of various additional functions. For example, some functions could be changing the color of the paint being sprayed, changing the flow rate of the paint being sprayed, or displaying a virtual menu consisting a number of choices from which the user can choose. Another function could be toggling between a “default” action mode and another type of action mode. In this example, the “default” action mode could set the spray-painting tool to spray a default color of paint and the other type of action mode could set the spray-painting tool to spray a different color of paint. Alternatively, in this example, the “default” action mode could set the spray-painting tool to spray paint at a default flow rate and the other type of action mode could set the spray-painting tool to spray paint at a user specified flow rate.

Texture Tool

According to another embodiment, the three-dimensional virtual tool of the present invention is a texture-spraying tool. This tool's primary function is to spray various amounts of virtual texture onto regions of three-dimensional virtual objects. This tool allows a user to spray texture on a portion of a three-dimensional virtual object by pointing the texture-spraying tool to the area of the virtual object that the user wants to texturize. The size of the three-dimensional region of the virtual object that the texture-spraying tool texturizes is dependent upon the distance the user holds the tool from the virtual object. The rate of texture that being sprayed by the texture-spraying tool is set to a default predetermined setting.

According to one embodiment, the texture-spraying tool's physical component can be manufactured to have additional controls which can be used to activate additional features. For example some types of controls could be, and not limited to, buttons, joysticks, scroll wheels, foot pedals, or other sensors that are embedded into the methodology itself. The other sensors that are embedded in the methodology itself could be used to sense, for example, when the user applies pressure to a device with a thumb. These additional controls can be used to activate a number of various additional functions. For example, some functions could be changing the type of texture being sprayed, changing the amount of texture being sprayed, or displaying a virtual menu consisting a number of choices from which the user can choose. Another function could be toggling between a “default” action mode and another type of action mode. In this example, the “default” action mode could set the texture-spraying tool to spray a default type of texture and the other type of action mode could set the texture-spraying tool to spray a different type of texture. Alternatively, in this example, the “default” action mode could set the texture-spraying tool to spray texture at a default rate and the other type of action mode could set the texture-spraying tool to spray texture at a user specified rate.

Three-Dimensional Video Game Controllers

According to one embodiment, the present invention provides for a number of three-dimensional video game controllers. These controllers allow a new class of video games in which the player directly manipulates three-dimensional objects.

Video games have recently found the ability to render three-dimensional form using advanced computer hardware, as seen in many games released since the mid-1990's. In addition, there are many new games that use devices such as dance pads and snowboard as controllers to enhance video games. The present invention allows for commonplace methodologies to more richly interact with the three-dimensional graphics. These methodologies are applications of the tools developed for spatial design in the area of video gaming.

Grabbing Controller—Tongs in a Game Scenario

The tongs closing around a shape can signal many events in a game. For example, a game has enemies fly towards a player. Closing the tongs around the enemies can, for example, kill them and gain the user points or help the user advance to the next level.

The grabbing controller can be used for other forms of manipulation that entail rotating and moving objects as well. For example, another game involves three-dimensional puzzle pieces. In this game the player grabs the puzzle pieces with the tongs and links them together to form larger structures. In some cases these pieces move, in other cases the pieces do not. In other variants of this game, the player can also bend and twist these objects, both by grabbing portions of an articulated skeleton with one tong, or by grabbing objects with two tongs. When grabbed with two tongs, objects are deformed, bent, scaled, and stretched for the purposes of the game, for example. For a game which uses this interaction, a player gets points for bending a shape to match a target form, and as this game advances, the player has to bend more complex shapes more quickly to gain points.

Other games that demonstrate the usefulness of this grabbing controller include a role playing game where many objects can be grabbed during the course of the game. In one example, the player navigates a three-dimensional world, grabbing objects such as weapons, food, gold, and clothing to enhance the abilities of a character in the game. In another game, this grabbing technique is used to arrange things to solve puzzles. In another game, players have to place objects in certain locations in a room to unlock a door and allow them to go into the next room. In yet another puzzle game, the objects have to touch one another, for example, to form complex objects.

Slicing and Placing with a Handle in a Game Scenario

The handle (physical component) with a laser beam (virtual component) can be used in a variety of games. For example, the device can be used in a game as a sword to fight an opponent. In this game, the opponent is a rendered three-dimensional digital character, and the opponent is damaged when the virtual component (laser beam) goes through the character. In another type of game, this sword is used to kill much smaller enemies. In another game, these characters appear as a swarm of flies, and the player is rewarded for moving the laser beam through a fly. The objective of this game is to kill insects, which could come in differing varieties and complexities as the player advances through the different levels of the game. In this type of game the remapping technique can be used, for example, to change from one type of sword to another or to cycle through an array of a variety of weapons. There is virtually no limitation to the range of weapons that such a handle can host.

The handle can also be used to drop objects in a scene as part of playing the game. For example, the objective of a game could be to destroy buildings using a variety of bombs. In this game, a player has to drop explosives on a building and destroy them in order to advance in the game. The player moves through the world using a navigation device similar to any number of navigational devices described earlier (grabbing, pointing, or gripping devices) to places bombs in certain areas. Then a tool such as the handle is used to place the bombs, and the menu described earlier is used to select the type of explosive that will be dropped. There is no limit to the nature of objects that can be placed with such a tool. While objects are commonly placed in video games, this tool allows them to be placed more richly by specifying all 6 DOFs as they are placed. This is one of the advantages of this style of interface for video games.

Shooting and Selecting with a Pointing Device in a Game Scenario

The pointing device described above can be used to shoot objects in a video game. For example, the objective of a game could be to shoot down the enemy. In this game, bullets come flying out of a gun. Unlike previous shooting video games where the user points at a screen, the present invention does not specify a two-dimensional screen coordinate for the shot, but rather a ray in three-dimensional space, which is a crucial distinction between the present invention and the prior art. In another game, the user uses the pointing device to select between a range of weapons to use against enemies. These weapons include, for example, a wide variety of real and fictional guns, flamethrowers, laser shooters, and weapons that hurl any variety of objects as projectile weapons.

Furthermore the pointing device can be used to select objects. For example, a tractor beam virtual component selects an object and as the player holds the trigger, the object moves towards the player. This can be used to grab or rearrange objects. Other games can be built on the use of a gun to highlight certain things, or to choose them. For example, a city-simulation strategy game can use this device to select a building. Once it is selected, a user can change the properties of the building, such as deciding to convert it into a factory, or to raise the rent of the apartments in this building. In this manner the pointing device can be used to point to three-dimensional game components during the course of playing the game. The pointing device can also be used to hold a beam that it moves to slice objects, or paint objects, which can be used in the two-handed methods described above.

Drawing Strokes in a Game Scenario

Drawing strokes, either with the hand, or through a much simpler method using the handle (where a one-dimensional curve is traced in three-dimensional space) can be used as an element of gameplay for three-dimensional immersive entertainment. For example, in one game the player draws strokes to match target strokes. The target strokes appear in a series, one after the other. After each target stroke appears, the player has five seconds to draw this target shape. If the player is successful in drawing the target shape, the game proceeds to the next level where the shapes become more complex.

Strokes can be used in a wide variety of three-dimensional video games, for example in games where the objective is to draw a stroke around an enemy form. For example, the player draws strokes to block the path of an enemy robot. Each stroke serves as a boundary which forces the robot to turn around. The objective here is to draw a series of strokes to trap the robot. This game shows how strokes can be used as objects which other characters interact with. This is useful for games which entail creating part of a world as a portion of gameplay.

Navigation in a Game Scenario

The present invention provides a rich means for navigating a player through a video game world, and many other manipulations of game space. For example, the tongs described earlier can be used to grab a world inside a game and move it, or when a player grabs empty space and moves the tongs, the world moves as well. The player, seeing the world in a first person perspective, perceives to be moving through the world. The device can also be used to guide a vehicle that the player perceives to be in. For example, the handle controls the navigation of a plane. Moving the handle to the left makes the plane bank to the left, and the player views a changing scenery to reflect the change in direction similar to what the player would view in a real-life situation. Moving the handle forward or backwards can control the speed of the plane. Note this is also effective in situations when the player is not controlling a plane, but another device. This is also effective when, instead of the handle, a hand, or a form of a plane (for example, a small toy plane with sensors in it) is used as an input device. A similar type of navigation can be used to move a player, for example, through tunnel-like spaces, or along a racetrack. In this type of game a device is waved to signify the direction and velocity of the player along the path, and the character in the video game responds accordingly.

Non-Controller-Specific Three-Dimensional Interactions in a Game Scenario

The present invention embodies other interactions that do not depend on a certain form of controller, but are still unique to the three-dimensional gaming setting. For example, in an interactive video game where an enemy flies towards the player's input device, and the player must move the form away from the enemy. There are many such styles of play which are supported by the present invention. In another example video game scenario, a weapon lies on a rubber band that is between two devices. Moving the input device moves the rubber band and the attached weapon. Similarly weapons can be dangled from virtual components that look like strings and swung at players.

Another class of interactions with the gaming world involves specifying regions of space within a game domain. In one such game, the player draws toxic areas in three-dimensional space. In this game, the user (who is representing the “good guy” in the game) is bombarded by flying enemies. One of the tools the user has allows the user to draw a region such that if the enemy flies through this region, the enemy is killed. This is one of many ways a user can make use of the improved interface tools of the present invention Another way of playing this game is for the user to draw three-dimensional windows in space analogous to the region above. The player activates the input device, drags it, and releases it. A square is formed spanning the start and end points, and this square forms a window. If the enemy goes through this window they disappear.

Thus, a method and an apparatus for using both physical and digital input methodologies to implement two and three-dimensional spatial manipulation is described in conjunction with one or more specific embodiments. The invention is defined by the following claims and their full scope of equivalents.

We claim:

1. A method for two-dimensional or three-dimensional spatial manipulation or two-dimensional or three-dimensional entertainment, comprising:
generating one or more interface devices to alter and generate one or more two-dimensional or three-dimensional virtual objects, wherein said devices can control N degrees of freedom of said virtual objects;
associating said interface devices in conjunction with each other to alter one or more two-dimensional or three-dimensional virtual components;
providing one or more three-dimensional virtual tools to a user for said spatial manipulation or said two-dimensional or said three-dimensional entertainment; and
providing a plurality of video game controllers to said user for said spatial manipulation or said two-dimensional or said three-dimensional entertainment.

2. The method of claim 1 wherein said interface devices are digital input devices.

3. The method of claim 1 wherein said interface devices are physical input devices.

4. The method of claim 1 wherein said virtual components are a software representation of one or more physical input devices, wherein said software representation has a two-dimensional or three-dimensional rendering associated with it.

5. The method of claim 1 wherein one of said virtual components is a two-dimensional GUI.

6. The method of claim 1 wherein one of said virtual component is a three-dimensional GUI.

7. The method of claim 1 wherein one of said virtual components is a cursor on a computer screen.

8. The method of claim 1 wherein one of said interface devices is a grabbing tool.

9. The method of claim 8 wherein said grabbing tool has a physical form resembling a pair of kitchen tongs.

10. The method of claim 8 wherein said grabbing tool has a physical form resembling a pair of pincers.

11. The method of claim 8 wherein said grabbing tool has a physical form resembling a pair of scissors.

12. The method of claim 8 wherein said grabbing tool has a physical form resembling a pair of tweezers.

13. The method of claim 8 wherein a first virtual form of said grabbing tool is an iconic virtual component only.

14. The method of claim 8 wherein a second virtual form of said grabbing tool is a first iconic virtual component coupled with a second virtual component that coincides with said tool's physical form.

15. The method of claim 8 wherein a third virtual form of said grabbing tool is a virtual component coinciding with said tool's physical form.

16. The method of claim 8 wherein a fourth virtual form of said grabbing tool is a lack of virtual depiction.

17. The method of claim 8 further comprises:
altering the relationship between said grabbing tool and its corresponding three-dimensional virtual component;
mapping said grabbing tool to said corresponding virtual component;
controlling position of said corresponding virtual component to one of said virtual objects; and
generating an iconic form when said corresponding virtual component is close enough to react with one of said virtual objects.

18. The method of claim 17 wherein said controlling comprises embedding one or more sensors within said virtual component.

19. The method of claim 18 wherein said sensors is any one of magnetic, optical, or inertial sensors.

20. The method of claim 17 wherein said controlling position comprises integrating said virtual component within a controlling environment.

21. The method of claim 20 wherein said controlling environment is a camera.

22. The method of claim 8 wherein said grabbing tool has a plurality of controls to activate one or more functions.

23. The method of claim 22 wherein said plurality of controls comprises buttons, joysticks, scroll wheels, or foot pedals embedded in said virtual component.

24. The method of claim 22 wherein one of said functions is to display to said user a virtual menu consisting of one or more choices for said user to choose from.

25. The method of claim 22 wherein one of said functions is to toggle between a first action mode and a second action mode.

26. The method of claim 25 wherein said first action mode is a default action mode.

27. The method of claim 22 wherein one of said functions is to release a plurality of virtual weapons of one or more type.

28. The method of claim 1 wherein one of said interface devices is a pointing tool.

29. The method of claim 28 wherein said pointing tool has a physical form resembling a firearm.

30. The method of claim 29 wherein said firearm is a gun.

31. The method of claim 28 wherein said pointing tool has a physical form resembling a laser pointer.

32. The method of claim 28 wherein said pointing tool has a physical form resembling a camera.

33. The method of claim 28 wherein said pointing tool has a physical form resembling a pointing hand.

34. The method of claim 28 wherein said pointing tool has a physical form resembling a stick.

35. The method of claim 28 wherein said pointing tool has a physical form resembling a flashlight.

36. The method of claim 28 wherein said pointing tool has a physical form resembling a spray-paint can.

37. The method of claim 28 wherein said pointing tool has a physical form resembling a glue-gun.

38. The method of claim 28 wherein a first virtual form of said pointing tool is an iconic virtual component only.

39. The method of claim 28 wherein a second virtual form of said pointing tool is a first iconic virtual component coupled to a second virtual component that coincides with said tool's physical form.

40. The method of claim 28 wherein a third virtual form of said pointing tool is a virtual component coinciding with said tool's physical form.

41. The method of claim 28 wherein a fourth virtual form of said pointing tool is a lack of virtual depiction.

42. The method of claim 28 further comprises:
altering the relationship between said pointing tool and its corresponding three-dimensional virtual component;
mapping said pointing tool to said corresponding virtual component;
controlling position of said corresponding virtual component to one of said virtual objects; and
generating an iconic form when said corresponding virtual component is close enough to react with one of said virtual objects.

43. The method of claim 42 wherein said controlling comprises embedding one or more sensors within said virtual component.

44. The method of claim 43 wherein said sensors is any one of magnetic, optical, or inertial sensors.

45. The method of claim 42 wherein said controlling position comprises integrating said virtual component within a controlling environment.

46. The method of claim 45 wherein said controlling environment is a camera.

47. The method of claim 28 wherein said pointing tool has a plurality of controls to activate one or more functions.

48. The method of claim 47 wherein said plurality of controls comprises buttons, joysticks, scroll wheels, or foot pedals embedded in said virtual component.

49. The method of claim 47 wherein one of said functions is to display to said user a virtual menu consisting of one or more choices for said user to choose from.

50. The method of claim 47 wherein one of said functions is to toggle between a first action mode and a second action mode.

51. The method of claim 50 wherein said first action mode is a default action mode.

52. The method of claim 47 wherein one of said functions is to release a plurality of virtual weapons of one or more type.

53. The method of claim 1 wherein one of said interface devices is a gripping tool.

54. The method of claim 53 wherein said gripping tool has a physical form resembling a handle.

55. The method of claim 54 wherein said handle is a sword handle.

56. The method of claim 54 wherein said handle is a shovel handle.

57. The method of claim 53 wherein a first function of said gripping tool is to place said virtual objects in a three-dimensional space.

58. The method of claim 53 wherein a second function of said gripping tool is to draw one or more paths between two or more of said virtual objects.

59. The method of claim 53 wherein a first virtual form of said gripping tool is an iconic virtual component only.

60. The method of claim 53 wherein a second virtual form of said gripping tool is a first iconic virtual component coupled with a second virtual component that coincides with said tool's physical form.

61. The method of claim 53 wherein a third virtual form of said gripping tool is a virtual component coinciding with said tool's physical form.

62. The method of claim 53 wherein a fourth virtual form of said gripping tool is a lack of virtual depiction.

63. The method of claim 53 further comprises:
altering the relationship between said gripping tool and its corresponding three-dimensional virtual component;
mapping said gripping tool to said corresponding virtual component;
controlling position of said corresponding virtual component to one of said virtual objects; and
generating an iconic form when said corresponding virtual component is close enough to react with one of said virtual objects.

64. The method of claim 63 wherein said controlling comprises embedding one or more sensors within said virtual component.

65. The method of claim 64 wherein said sensors is any one of magnetic, optical, or inertial sensors.

66. The method of claim 63 wherein said controlling position comprises integrating said virtual component within a controlling environment.

67. The method of claim 66 wherein said controlling environment is a camera.

68. The method of claim 53 wherein said grabbing tool has a plurality of controls to activate one or more functions.

69. The method of claim 68 wherein said plurality of controls comprises buttons, joysticks, scroll wheels, or foot pedals embedded in said virtual component.

70. The method of claim 68 wherein one of said functions is to display to said user a virtual menu consisting of one or more choices for said user to choose from.

71. The method of claim 68 wherein one of said functions is to toggle between a first action mode and a second action mode.

72. The method of claim 71 wherein said first action mode is a default action mode.

73. The method of claim 68 wherein one of said functions is to release a plurality of virtual weapons of one or more type.

74. A method to draw a virtual object in a two-dimensional or three-dimensional space or in a two-dimensional or three-dimensional entertainment environment, comprising:
using two or more physical input devices coincidentally.

75. The method of claim 74 wherein using two or more physical input devices further comprises:
using said grabbing tool in combination with said pointing tool to create a solid curve or volume.

76. The method of claim 75 wherein said using grabbing tool in combination with said pointing tool further comprises:
using said grabbing tool to grab said pointing tool's virtual object;
bending said virtual object of said pointing tool with said grabbing tool; and
sweeping said pointing tool in said three-dimensional space or entertainment environment to create said curve or volume.

77. The method of claim 76 wherein said sweeping causes a three-dimensional solid curve if said curve is not a closed loop.

78. The method of claim 76 wherein said sweeping causes a three-dimensional solid volume if said curve is a closed loop.

79. A method to assemble and rearrange a virtual molecule in a two-dimensional or three-dimensional space or in a two-dimensional or three-dimensional entertainment environment, comprising:
using said grabbing tool in combination with said gripping tool and said pointing tool.

80. The method of claim 79 wherein said using further comprises:
using one of said gripping tool's plurality of controls to activate one or more of said gripping tool's functions to construct said molecule;
using said pointing tool to draw one or more bonds of said molecule;
using said grabbing tool to move said molecule to a position in said three-dimensional space or entertainment environment for easier drawing of said bonds; and
using said gripping tool to break any one or more of said bonds.

81. A method to change placement of a virtual object in a two-dimensional or three-dimensional space or in a two-dimensional or three-dimensional entertainment environment, comprising:
using two or more of said physical input devices coincidentally.

82. The method of claim 81 wherein said using two or more physical input devices further comprises:
using a first grabbing tool in conjunction with a second grabbing tool to rotate said virtual object in two-dimensional or three-dimensional space or in a three-dimensional entertainment environment.

83. The method of claim 82 wherein said using further comprises:
grabbing a first extremity of said virtual object with said first grabbing tool;
grabbing a second extremity of said virtual object with said second grabbing tool; and
rotating said virtual object to a desired position in said two-dimensional or three-dimensional space or three-dimensional entertainment environment by moving one or both of said first grabbing tool and said second grabbing tool.

84. A method to deform a virtual object in a two-dimensional or three-dimensional space or in a two-dimensional or three-dimensional entertainment environment, comprising:
using two or more of said physical input devices coincidentally.

85. The method of claim 84 wherein said using two or more physical input devices further comprises:
using a first grabbing tool in conjunction with a second grabbing tool to stretch said virtual object in two-dimensional or three-dimensional space or in a three-dimensional entertainment environment.

86. The method of claim 84 wherein said using two or more physical input devices further comprises:
using a first grabbing tool in conjunction with a second grabbing tool to twist said virtual object in two-dimensional or three-dimensional space or in a three-dimensional entertainment environment.

87. A method to alter a physical input device's virtual object in a two-dimensional or three-dimensional space or in a two-dimensional or three-dimensional entertainment environment, comprising:
using two or more of said physical input devices coincidentally.

88. The method of claim 87 wherein said using two or more physical input devices further comprises:
using a first grabbing tool to modify an axis of rotation of a second grabbing tool in two-dimensional or three-dimensional space or in a three-dimensional entertainment environment.

89. The method of claim 88 wherein said using further comprises:
using said first grabbing tool to grab said second grabbing tool's virtual component;
using said first grabbing tool to move said virtual component of said second grabbing tool to a desired location in two-dimensional or three-dimensional space or three-dimensional entertainment environment in relationship to said second grabbing tool; and
using said second grabbing tool to rotate said virtual object once said virtual component is positioned in said desired location.

90. A method to specify a point in a two-dimensional or three-dimensional space or in a two-dimensional or three-dimensional entertainment environment, comprising:
using two or more of said physical input devices coincidentally.

91. The method of claim 90 wherein said using two or more physical input devices further comprises:
using a first pointing tool and a second grabbing tool to specify a point in two-dimensional or three-dimensional space or in a three-dimensional entertainment environment.

92. The method of claim 91 wherein said using further comprises:
intersecting a virtual object of said first pointing tool and a virtual object of said second pointing tool to denote said point in said two-dimensional or three-dimensional space or in a three-dimensional entertainment.

93. The method of claim 92 wherein said virtual object of said first pointing tool and said second pointing tool resembles a laser beam.

94. The method of claim 92 wherein said virtual object of said second pointing tool resembles a plane emanating from a barrel of a gun.

95. A method for altering the spatial relationship between a physical input device and one or more of its two or three-dimensional virtual components, comprising:
using a first physical input device and a second physical input device coincidentally.

96. The method of claim 95 wherein said using a first and a second physical input device further comprises:
using said first physical input device and said second physical input device to cut a virtual object located at a position in said two-dimensional or three-dimensional space or three-dimensional entertainment environment.

97. The method of claim 96 wherein said using further comprises:
using said first physical input device to grab said second physical input device's virtual object;
using said first physical device to lengthen said virtual object until it reaches a desired length; and
using said second physical input device to cut said virtual object.

98. A method to map a plurality of virtual components to one physical input device, comprising:
using a virtual menu to map said plurality of virtual components to said physical input device.

99. The method of claim 98 wherein said virtual menu is activated via an additional control on said physical input device.

100. A method to change a plurality of virtual components mapped to a physical input device, comprising:
using a virtual menu to change said plurality of virtual components mapped to said physical device.

101. The method of claim 100 wherein said virtual menu is activated via an additional control on said physical input device.

102. The method of claim 1 wherein each of said three-dimensional virtual tools has a virtual form further comprising:
an iconic virtual component only;
an iconic virtual component along with a virtual component that resembles said tool's physical form;
a virtual component only that resembles said tool's physical form; and
a virtual component lacking virtual depiction.

103. The method of claim 102 further comprises: controlling position of three-dimensional virtual component to one of said virtual objects.

104. The method of claim 103 wherein said controlling comprises embedding one or more sensors within said virtual component.

105. The method of claim 104 wherein said sensors is any one of magnetic, optical, or inertial sensors.

106. The method of claim 104 wherein said sensors can activate one or more functions.

107. The method of claim 106 wherein said functions further comprises: monitoring when said virtual tool is moved from a default location; and monitoring when said virtual tool is being held by said user.

108. The method of claim 103 wherein said controlling comprises integrating said virtual component within a controlling environment.

109. The method of claim 108 wherein said controlling environment is a camera.

110. The method of claim 1 wherein one of said three-dimensional virtual tool is an eraser tool, wherein said tool is used to remove a region of a virtual surface.

111. The method of claim 1 wherein one of said three-dimensional virtual tool is a deformation tool, wherein said tool is used to deform the geometry of said virtual component.

112. The method of claim 1 wherein one of said three-dimensional virtual tool is a smoothing tool, wherein said tool is used to smooth a surface of said virtual component.

113. The method of claim 1 wherein one of said three-dimensional virtual tool is a spray-painting tool, wherein said tool is used to spray said virtual component with virtual paint.

114. The method of claim 1 wherein one of said three-dimensional virtual tool is a texture creation tool, wherein said tool is used to spray a texture on said virtual component.

115. The method of claim 10 wherein said eraser tool has a plurality of controls to activate one or more functions.

116. The method of claim 115 wherein said plurality of controls comprises buttons, joysticks, scroll wheels, or foot pedals embedded in said tool.

117. The method of claim 115 wherein one of said functions is to change a size of a default erasing region.

118. The method of claim 115 wherein one of said functions is to display to said user a virtual menu consisting of one or more choices for said user to choose from.

119. The method of claim 115 wherein one of said functions is to toggle between a first action mode and a second action mode.

120. The method of claim 119 wherein said first action mode is a default action mode.

121. The method of claim 111 wherein said deformation tool has a plurality of controls to activate one or more functions.

122. The method of claim 121 wherein said plurality of controls comprises buttons, joysticks, scroll wheels, or foot pedals embedded in said tool.

123. The method of claim 121 wherein one of said functions is to change a sensitivity of deformation of said virtual component.

124. The method of claim 121 wherein one of said functions is to display to said user a virtual menu consisting of one or more choices for said user to choose from.

125. The method of claim 121 wherein one of said functions is to toggle between a first action mode and a second action mode.

126. The method of claim 125 wherein said first action mode is a default action mode.

127. The method of claim 112 wherein said smoothing tool has a plurality of controls to activate one or more functions.

128. The method of claim 127 wherein said plurality of controls comprises buttons, joysticks, scroll wheels, or foot pedals embedded in said tool.

129. The method of claim 127 wherein one of said functions is to change a size of a soothing region of said virtual component.

130. The method of claim 127 wherein one of said functions is to change a degree of smoothing of said virtual component.

131. The method of claim 127 wherein one of said functions is to display to said user a virtual menu consisting of one or more choices for said user to choose from.

132. The method of claim 127 wherein one of said functions is to toggle between a first action mode and a second action mode.

133. The method of claim 132 wherein said first action mode is a default action mode.

134. The method of claim 113 wherein said spray-painting tool has a plurality of controls to activate one or more functions.

135. The method of claim 134 wherein said plurality of controls comprises buttons, joysticks, scroll wheels, or foot pedals embedded in said tool.

136. The method of claim 134 wherein one of said functions is to change a color of a paint sprayed on said virtual component.

137. The method of claim 134 wherein one of said functions is to change a flow rate of said paint being sprayed on said virtual component.

138. The method of claim 134 wherein one of said functions is to display to said user a virtual menu consisting of one or more choices for said user to choose from.

139. The method of claim 134 wherein one of said functions is to toggle between a first action mode and a second action mode.

140. The method of claim 139 wherein said first action mode is a default action mode.

141. The method of claim 114 wherein said texture creation tool has a plurality of controls to activate one or more functions.

142. The method of claim 141 wherein said plurality of controls comprises buttons, joysticks, scroll wheels, or foot pedals embedded in said tool.

143. The method of claim 141 wherein one of said functions is to change a type of texture sprayed on said virtual component.

144. The method of claim 141 wherein one of said functions is to change a flow rate of said texture being sprayed on said virtual component.

145. The method of claim 141 wherein one of said functions is to display to said user a virtual menu consisting of one or more choices for said user to choose from.

146. The method of claim 141 wherein one of said functions is to toggle between a first action mode and a second action mode.

147. The method of claim 146 wherein said first action mode is a default action mode.

148. The method of claim 1 wherein one of said controller is a grabbing controller, wherein said controller is used to grab said one or more virtual objects in said entertainment environment.

149. The method of claim 148 wherein said grabbing controller is used to rotate said one or more virtual objects.

150. The method of claim 148 wherein said grabbing controller is used to move said one or more virtual objects.

151. The method of claim 1 wherein one of said controllers is a slicing controller, wherein said controller is used to slice and relocate said one or more virtual objects in said entertainment environment.

152. The method of claim 151 wherein one of said slicing controller's physical shape is a handle and one of its virtual component is a laser beam.

153. The method of claim 152 wherein said handle shaped slicing controller is used to drop objects in said entertainment environment.

154. The method of claim 1 wherein one of said controllers is a pointing controller, wherein said controller is used to shoot said one or more virtual objects in said entertainment environment.

155. The method of claim 154 wherein said pointing controller is used to select said one or more virtual objects in said entertainment environment.

156. The method of claim 154 wherein said pointing controller is used to grab or rearrange said one or more virtual objects in said entertainment environment.

157. The method of claim 1 wherein one of said controllers is a drawing controller, wherein said controller is used to draw a stroke in said entertainment environment.

158. The method of claim 157 wherein said stroke is drawn freehand by said user in said entertainment environment.

159. The method of claim 157 wherein said stroke is drawn using said handle by said user in said entertainment environment.

160. The method of claim 1 wherein one of said controllers is a navigation controller, wherein said controller is used to navigate said user in said entertainment environment.

161. The method of claim 1 wherein N degrees of freedom is 6 degrees of freedom.

162. The method of claim 1 wherein N degrees of freedom is more than 6 degrees of freedom.
